(19) United States
(12) Patent Application Publication
(10) Pub. No.: US 2018/0205886 A1
(43) Pub. Date: Jul. 19, 2018

(54) IMAGE SENSOR AND METHOD OF OPERATING THE SAME

(71) Applicant: Samsung Electronics Co., Ltd., Suwon-si (KR)

(72) Inventors: Seon-ju Lee, Seoul (KR); Dae-hwa Paik, Seoul (KR); Seung-hyun Lim, Hwaseong-si (KR); Kyoung-min Koh, Hwaseong-si (KR); Min-ho Kwon, Seoul (KR); Jin-woo Kim, Seoul (KR)

(21) Appl. No.: 15/684,276

(22) Filed: Aug. 23, 2017

(30) Foreign Application Priority Data
Jan. 16, 2017 (KR) 10-2017-0007032

(51) Int. Cl. H04N 5/232; H04N 5/369; H04N 5/345; H04N 5/378

(52) U.S. Cl. CPC H04N 5/23245; H04N 5/378; H04N 5/345; H04N 5/3698

(57) ABSTRACT

In some embodiments, a method of operating an image sensor supporting a low speed mode and a high speed mode includes: outputting a first set of output signals from a first pixel group to a first output line group by enabling, during a first period of the low speed mode, a first load circuit group connected to the first set of output signals; outputting a second set of output signals from a second pixel group to a second output line group by enabling, during a second period of the low speed mode different from the first period, a second load circuit group connected to the second set of output signals; and disabling the second load circuit group during at least a part of the first period.

### CROSS-REFERENCE TO RELATED APPLICATION

This application claims the benefit of priority to Korean Patent Application No. 10-2017-0007032, filed on Jan. 16, 2017, in the Korean Intellectual Property Office, the disclosure of which is incorporated herein in its entirety by reference.

### BACKGROUND

The present disclosure relates to an image sensor, and more particularly, to an image sensor supporting different operation modes, and a method of operating the image sensor.

An image sensor may include a pixel array including a plurality of pixels each including a light detecting device, and may output an electric signal according to intensity of detected light. In order to form one image, an electric signal generated by each of the plurality of pixels may be converted and collected.

Time consumed to obtain all electric signals generated by the plurality of pixels included in the pixel array may be a factor determining performance of the image sensor. Also, the image sensor may be used in a battery-operated electronic device, such as a digital camera, a mobile phone, or a camcorder, and power consumed by the image sensor may also be a factor determining the performance of the image sensor.

### SUMMARY

The present disclosure provides an image sensor supporting different operation modes and having low power consumption, and a method of operating the image sensor.

In some embodiments, an image sensor supporting a low speed mode and a high speed mode includes a pixel array comprising a first pixel group including at least a first row of pixels and a second pixel group including at least a second row of pixels; a first output line group including a plurality of output lines connected to pixels of the first pixel group and configured to output a first set of output signals from the first row of pixels of the first pixel group during a first period of the low speed mode; a second output line group including a plurality of output lines connected to pixels of the second pixel group and configured to output a second set of output signals from the second row of pixels of the second pixel group during a second period of the low speed mode; a first load circuit group including a plurality of first load circuits configured to provide respective current loads for the plurality of output lines of the first output line group, each first load circuit of the first load circuit group configured to receive a first load control signal; a second load circuit group including a plurality of second load circuits configured to provide respective current loads for the plurality of output lines of the second output line group, each second load circuit of the second load circuit group configured to receive a second load control signal; and a control circuit configured to provide the second load control signal such that the second load circuit group is disabled during at least a part of the first period.

In some embodiments, a method of operating an image sensor supporting a low speed mode and a high speed mode includes: outputting a first set of output signals from a first pixel group to a first output line group by enabling, during a first period of the low speed mode, a first load circuit group connected to the first set of output signals; outputting a second set of output signals from a second pixel group to a second output line group by enabling, during a second period of the low speed mode different from the first period, a second load circuit group connected to the second set of output signals; and disabling the second load circuit group during at least a part of the first period.

In some embodiments, a method of operating an image sensor having a pixel array including a plurality of rows of pixels includes a low speed mode and a high speed mode. During a first time period of the low speed mode a first load circuit connected to a first output line connected to a plurality of pixels in a first column of the pixel array is enabled, pixel data from a first pixel in a first row and the first column of the pixel array is output, and a second load circuit connected to a second output line connected to a plurality of pixels in a second column of the pixel array is disabled. During a second time period of the low speed mode different from the first time period, the second load circuit connected to the second output line is enabled, pixel data from a second pixel in a second row and the second column of the pixel array is output, and the first load circuit is disabled. During the high speed mode the first load circuit and the second load circuit are simultaneously enabled in order to output pixel data from the first pixel simultaneously with outputting pixel data from the second pixel.

### BRIEF DESCRIPTION OF THE DRAWINGS

Embodiments of the inventive concept will be more clearly understood from the following detailed description taken in conjunction with the accompanying drawings in which:

FIG. 1 is a block diagram of an image sensor according to an embodiment;

FIG. 2A is a block diagram of some pixels of a pixel array of FIG. 1, and circuits related to the pixels, according to an embodiment, and FIG. 2B is a circuit diagram of examples of the pixels of FIG. 2A, according to an embodiment;

FIG. 3 is a timing diagram of signals of FIG. 2A according to passage of time, according to an embodiment;

FIG. 4 is a block diagram of some pixels of the pixel array of FIG. 1, and circuits related to the pixels, according to an embodiment;

FIGS. 5A and 5b are timing diagrams of signals of FIG. 4 according to passage of time, according to certain embodiments;

FIG. 6A is a block diagram of some pixels of the pixel array of FIG. 1, and circuits related to the pixels, according to an embodiment, and FIG. 6B is a circuit diagram of examples of shared-pixels of FIG. 6A, according to an embodiment;

FIG. 7 is a timing diagram of signals of FIG. 6A according to passage of time, according to an embodiment;

FIG. 8 is a timing diagram of signals of FIG. 6A according to passage of time, according to another embodiment;

FIGS. 9A through 9D are block diagrams of some pixels of the pixel array of FIG. 1, according to certain embodiments;

FIG. 10 is a block diagram of an image sensor according to another embodiment;

FIG. 11 is a block diagram of some pixels of a pixel array of FIG. 10, and circuits related to the pixels, according to an embodiment;

FIG. 12 is a timing diagram of signals of FIG. 11 according to passage of time, according to an embodiment;

FIG. 13 is a flowchart of a method of operating an image sensor, according to an embodiment;

FIG. 14 is a flowchart of an example of operation S500 of FIG. 13, according to an embodiment; and

FIGS. 15A and 15B are flowcharts of different examples of operations S520 of FIG. 14, according to embodiments.

### DETAILED DESCRIPTION

The present disclosure now will be described more fully hereinafter with reference to the accompanying drawings, in which various embodiments are shown. Though the different figures show variations of exemplary embodiments, and may be referred to using language such as “in one embodiment,” these figures are not necessarily intended to be mutually exclusive from each other. Rather, as will be seen from the context of the detailed description below, certain features depicted and described in different figures can be combined with other features from other figures to result in various embodiments, when taking the figures and their description as a whole into consideration.

It will be understood that, although the terms first, second, third etc. may be used herein to describe various elements, components, regions, layers and/or sections, these elements, components, regions, layers and/or sections should not be limited by these terms. Unless the context indicates otherwise, these terms are only used to distinguish one element, component, region, layer or section from another element, component, region, layer or section, for example as a naming convention. Thus, a first element, component, region, layer or section discussed below in one section of the specification could be termed a second element, component, region, layer or section in another section of the specification or in the claims without departing from the teachings of the present invention. In addition, in certain cases, even if a term is not described using “first,” “second,” etc., in the specification, it may still be referred to as “first” or “second” in a claim in order to distinguish different claimed elements from each other.

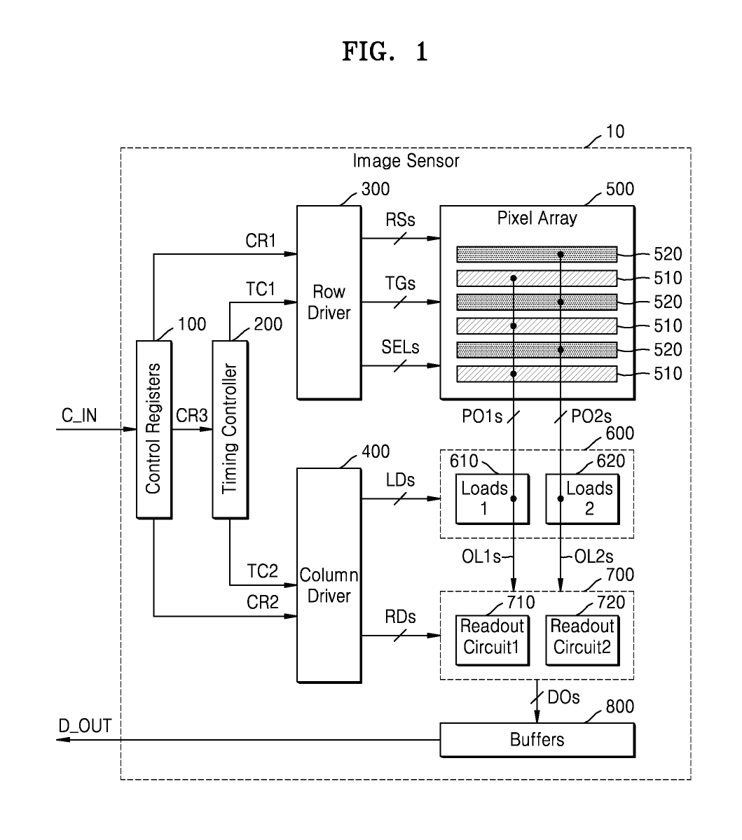

FIG. 1 is a block diagram of an image sensor 10 according to an embodiment. As shown in FIG. 1, the image sensor 10 may include control registers 100, a timing controller 200, a row driver 300, a column driver 400, a pixel array 500, load circuits 600, readout circuits 700, and buffers 800. The image sensor 100 may receive a control input signal C_IN and output a data output signal D_OUT when the pixel array 500 detects light.

The image sensor 10 may support different operation modes. For example, the image sensor 10 may support a high speed mode, a low speed mode, and a standby mode. The image sensor 10 may output the data output signal D_OUT by reading signals, such as first and second output signal groups PO1s and POS2, output from the pixel array 500 in the high speed mode, at a relatively high speed. On the other hand, the image sensor 10 may output the data output signal D_OUT by reading the signals, such as the first and second output signal groups PO1s and POS2, output from the pixel array 500 in the low speed mode, at a relatively low speed. As described below, the image sensor 10 may have lower power consumption in the low speed mode than in the high speed mode by disabling at least one component (for example, at least some of the readout circuits 700) included in the image sensor 10. Also, the image sensor 10 may have lower power consumption in the standby mode than in the low speed mode by disabling at least one component (for example, the load circuits 600 and the readout circuits 700) included in the image sensor 10.

The control registers 100 may include a plurality of registers storing values according to the control input signal C_IN. For example, the control input signal C_IN may include information about an operation mode of the image sensor 10, and the control registers 100 may include a register storing a value indicating the operation mode of the image sensor 10. As shown in FIG. 1, the control registers 100 may provide control by outputting first through third register signals CR1 through CR3 indicating values stored in the control registers 100 respectively to the row driver 300, the column driver 400, and the timing controller 200.

The timing controller 200 may control timing of operations of the image sensor 10. As shown in FIG. 1, the timing controller 200 may receive the third control register signal CR3 from the control register 100, and control the timing of operations of the image sensor 10 in response to the third control register signal CR3. For example, the timing controller 200 may set time consumed or needed to read output signals output from pixels included in one row of the pixel array 500, and generate first and second timing signals TC1 and TC2 according to the set time. Also, the timing controller 200 may set time consumed or needed to complete reading output signals output from all pixels included in the pixel array 500, and generate the first and second timing signals TC1 and TC2 according to the set time. As shown in FIG. 1, the timing controller 200 may provide the first and second timing signals TC1 and TC2 respectively to the row driver 300 and the column driver 400, and the row driver 300 and the column driver 400 may operate in response to the first and second timing signals TC1 and TC2. The row and column drivers 300 and 400 generating control signals may be integrally referred to as a control circuit. The control registers 100 and/or timing controller 200 may be part of the control circuit.

The row driver 300 may generate signals for controlling the pixel array 500. As shown in FIG. 1, the row driver 300 may generate reset control signals RSs, transmission control signals TGs, and selection control signals SELs to a plurality of pixels included in the pixel array 500, in response to the first control register signal CR1 received from the control register 100 and the first timing signal TC1 received from the timing controller 200. For example, the row driver 300 may recognize an operation mode of the image sensor 10 based on the first control register signal CR1, and determine activation of the reset control signals RSs, the transmission control signals TGs, and the selection control signals SELs based on the operation mode of the image sensor 10. Also, the row driver 300 may determine activating and deactivating timings of the reset control signals RSs, the transmission control signals TGs, and the selection control signals SELs based on the first timing signal TC1.

The column driver 400 may generate signals for controlling components receiving signals (for example, the first and second output signal groups PO1s and PO2s) output from the pixel array 500. As shown in FIG. 1, the column driver 400 may provide load control signals LDs and readout control signals RDs respectively to the load circuits 600 and the readout circuits 700, in response to the second control register signal CR2 received from the control register 100 and the second timing signal TC2 received from the timing controller 200. For example, the column driver 400 may recognize the operation mode of the image sensor 10 based on the second control register signal CR2, and determine activation of the load control signals LDs and the readout control signals RDs based on the operation mode of the image sensor 10. Also, the column driver 400 may determine activating and deactivating timings of the load control signals LDs and the readout control signals RDs based on the second timing signal TC2.

The pixel array 500 may include a plurality of pixels, and may output signals (for example, the first and second output signal groups PO1s and PO2s) through output lines (for example, first and second output line groups OL1s and OL2s), wherein the signals are output when the plurality of pixels detect light. As shown in FIG. 1, in one embodiment, the pixel array 500 may include a first pixel group 510 and a second pixel group 520 each including a plurality of pixels.

For example, the first pixel group 510 may include a plurality of pixels (e.g., all of the pixels) in a first row of pixels, a plurality of pixels (e.g., all of the pixels) in a third row of pixels, a plurality of pixels (e.g., all of the pixels) in a fifth row of pixels, etc. A set of pixels in a first column of pixels of the first pixel group 510, e.g., a first set of pixels including pixels from the first row, third row, fifth row, etc., may be connected in common to a first output line of the first output line group OL1s; a set of pixels in a second column of pixels of the first pixel group 510, e.g., a second set of pixels including pixels from the first row, third row, fifth row, etc., may be connected in common to a second output line of the first output line group OL1s, etc. The second pixel group 520 may include a plurality of pixels (e.g., all of the pixels) in a second row of pixels, a plurality of pixels (e.g., all of the pixels) in a fourth row of pixels, a plurality of pixels (e.g., all of the pixels) in a sixth row of pixels, etc. A set of pixels in a first column of pixels of the second pixel group 520, e.g., a first set of pixels including pixels from the second row, fourth row, sixth row, etc., may be connected in common to a first output line of the second output line group OL2s; a set of pixels in a second column of pixels of the second pixel group 520, e.g., a second set of pixels including pixels from the second row, fourth row, sixth row, etc., may be connected in common to a second output line of the second output line group OL1s, etc.

Thus, the first pixel group 510 may output the first output signal group PO1s through the first output line group OL1s, and the second pixel group 520 may output the second output signal group PO2s through the second output line group OL2s. As shown in FIG. 1, the first pixel group 510 may include a plurality of rows of the pixel array 500, and the second pixel group 520 may also include a plurality of rows of the pixel array 500. Therefore, control signals for controlling the first pixel group 510 and control signals for controlling the second pixel group 520 may not be the same. Although the first and second pixel groups 510 and 520 are alternately disposed in the pixel array 500 in FIG. 1, the first and second pixel groups 510 and 520 may be disposed in a manner different from FIG. 1.

The pixel array 500 may simultaneously output the first and second output signal groups PO1s and PO2s through the first and second output line groups OL1s and OL2s in the high speed mode, or may alternately output the first output signal group PO1s through the first output line group OL1s and the second output signal group PO2s through the second output line group OL2s in the low speed mode, in response to the reset control signals RSs, the transmission control signals TGs, and the selection control signals SELs provided from the row driver 300. For example, the row driver 300 may simultaneously activate a first selection control signal connected to some of pixels included in the first pixel group 510 and a second selection control signal connected to some of pixels included in the second pixel group 520, from among the selection control signals SELs, in the high speed mode, or may alternately activate the first and second selection control signals in the low speed mode.

In more detail, during the high speed mode, the pixel array 500 may output first output signals (e.g., a first set of output signals) from a first set of pixels in a first row of the pixel array 500 (e.g., a first row of the first pixel group 510) at the same time that it outputs second output signals (e.g., a second set of output signals) from a second set of pixels in a second row of the pixel array 500 (e.g., a first row of the second pixel group 520). Subsequently, the pixel array 500 may output third output signals (e.g., a third set of output signals) from a third set of pixels in a third row of the pixel array 500 (e.g., a second row of the first pixel group 510) at the same time that it outputs fourth output signals (e.g., a fourth set of output signals) from a fourth set of pixels in a fourth row of the pixel array 500 (e.g., a second row of the second pixel group 520). Subsequently, the pixel array 500 may output fifth output signals (e.g., a fifth set of output signals) from a fifth set of pixels in a fifth row of the pixel array 500 (e.g., a third row of the first pixel group 510) at the same time that it outputs sixth output signals (e.g., a sixth set of output signals) from a sixth set of pixels in a sixth row of the pixel array 500 (e.g., a third row of the second pixel group 520). For each column of pixels of the first pixel group 510, an individual output line may output a first, third, and fifth, etc., output signal associated with the column. For each column of pixels of the second pixel group 520, an individual output line may output a second, fourth, and sixth, etc., output signal associated with the column.

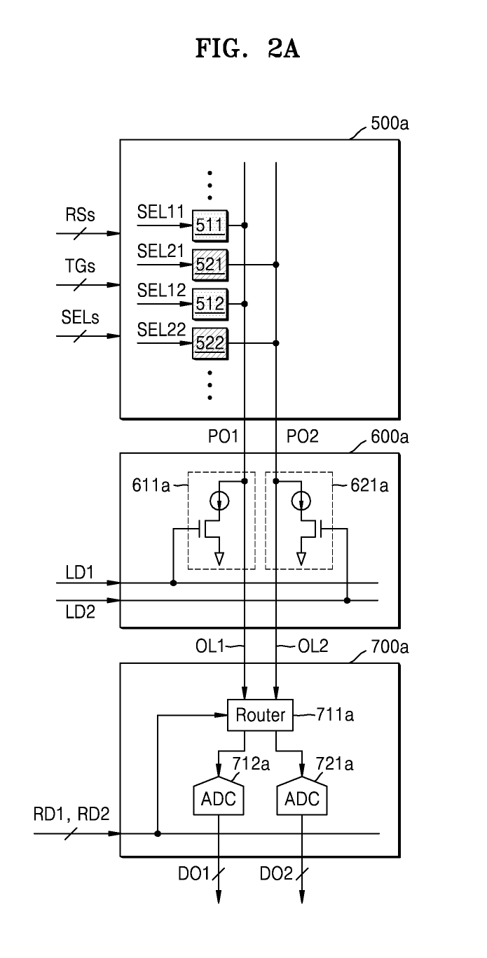

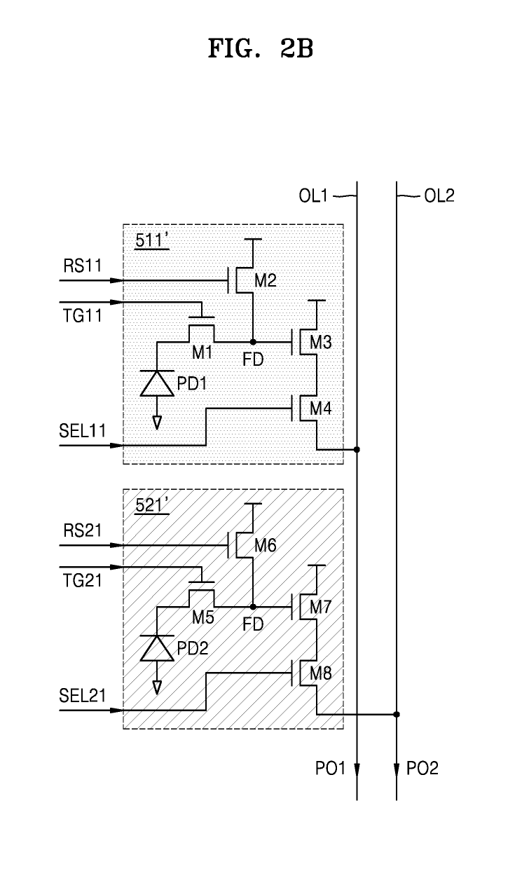

The load circuits 600 may provide loads such that signals (for example, signals from the first and second output signal groups PO1s and PO2s) output from the pixels of the pixel array 500 are transmitted to the readout circuits 700. For example, as will be described below with reference to FIG. 2B, the pixels included in the pixel array 500 may include amplifiers that amplify a signal generated when the pixels of the pixel array 500 detect light, and the load circuits 600 may provide loads for the amplifiers. As shown in FIG. 1, the load circuits 600 may include a first load circuit group 610 connected to the first output line group OL1s (e.g., first load circuits connected to respective first output lines) and a second load circuit group 620 connected to the second output line group OL2s (e.g., second load circuits connected to respective second output lines). The first and second load circuit groups 610 and 620 may be enabled or disabled based on the load control signals LDs provided by the column driver 400. For example, the first and second load circuit groups 610 and 620 may be simultaneously enabled in the high speed mode (e.g., the load circuits of the first load circuit group 610 may be enabled at the same time as the load circuits of the second load circuit group 620).

The column driver 400 may generate the load control signals LDs such that at least a part of the load circuits 600 is deactivated in the low speed mode. For example, for each pair of adjacent rows of pixels (e.g., first and second row; third and fourth row; etc.), the first load circuit group 610 may be activated in a first period (e.g., first time period) where signals from the first output signal group PO1s are output through the first output line group OL1s, while the second load circuit group 620 is deactivated in at least a part of the first period. Similarly, for the same pair of adjacent rows of pixels, the second load circuit group 620 may be activated in a second period (e.g., second time period) where signals from the second output signal group PO2s are output through the second output line group OL2s, while the first load circuit group 610 is deactivated in at least a part of the second period. Accordingly, power consumption of the image sensor 10 may be reduced according to a load circuit group deactivated in the low speed mode.

The readout circuits 700 may be connected to the first and second output line groups OL1s and OL2s, and output digital output signals DOs by converting the first and second output signal groups PO1s and PO2s. For example, the readout circuits 700 may include a plurality of analog-to-digital converters (ADCs) connected to the first and second output line groups OL1s and OL2s, wherein the plurality of ADCs generate the digital output signals DOs by converting the signals from the first and second output signal groups PO1s and PO2s that are analog signals. As shown in FIG. 1, the readout signals 700 may include a first readout circuit group 710 connected to the first output line group OL1s (e.g., first readout circuits connected to respective first output lines) and second readout circuit group 720 connected to the second output line group OL2s (e.g., second readout circuits connected to respective second output lines). The first and second readout circuit groups 710 and 720 may be activated or deactivated based on the readout control signals RDs provided by the column driver 400. For example, the first and second readout circuit groups 710 and 720 may be simultaneously activated in the high speed mode (e.g., first readout circuits of the first readout circuit group 710 may be activated at the same time as second readout circuits of the second readout circuit group 720), while one of the first and second readout circuit groups 710 and 720 may be deactivated in the low speed mode.

The buffers 800 may receive the digital output signals DOs from the readout circuits 700, and output the data output signal D_OUT. For example, the buffers 800 may include memories storing the digital output signals DOs, wherein the memories may store the digital output signals DOs received at least once.

FIG. 2A is a block diagram of some pixels of the pixel array 500 of FIG. 1, and circuits related to the pixels, according to an embodiment, and FIG. 2B is a circuit diagram of examples of pixels 511 and 521 of FIG. 2A. In FIGS. 2A and 2B, pixels 511 and 512 may be included in the first pixel group 510 of FIG. 1, and pixels 521 and 522 may be included in the second pixel group 520 of FIG. 1. Also, in FIGS. 2A and 2B, a first output signal PO1 and a second output signal PO2 may be respectively included in the first output signal group PO1s and the second output signal group PO2s of FIG. 1, and a first output line OL1 and a second output line OL2 may be respectively included in the first output line group OL1s and the second output line group OL2s of FIG. 1. Hereinafter, FIGS. 2A and 2B will be described with reference to FIG. 1.

Referring to FIG. 2A, in a pixel array 500a, the pixels 511 and 512 of the first pixel group 510 may be connected to the first output line OL1, and the pixels 521 and 522 of the second pixel group 520 may be connected to the second output line OL2. According to an embodiment, pixels disposed in the same column from among pixels of the first pixel group 510 may be connected to the same output line (e.g., a first output line), and pixels disposed in the same column from among the pixels of the second pixel group 520 may be connected to the same output line (e.g., a second output line different from the first output line).

Each of the pixels 511, 512, 521, and 522 may receive one of the selection control signals SELs provided from the row driver 300 of FIG. 1, and output an output signal to an output line in response to the activated selection control signal. For example, the pixel 511 of the first pixel group 510 may receive a selection control signal SEL11, and output the first output signal PO1 through the first output line OL1 in response to the activated selection control signal SEL11. Similarly, the pixel 521 of the second pixel group 520 may receive a selection control signal SEL21, and output the second output signal PO2 through the second output line OL2, which corresponds to an electric signal generated when the light is detected, in response to the activated selection control signal SEL21. Details of a pixel will be described below with reference to FIG. 2B.

As shown in FIG. 2A, load circuits 600a may receive first and second load control signals LD1 and LD2 from among the load control signals LDs provided from the column driver 400 of FIG. 1, and may include a first load circuit 611a included in the first load circuit group 610 of FIG. 1 and a second load circuit 621a included in the second load circuit group 620 of FIG. 1. The first and second load circuits 611a and 621a may be respectively connected to the first and second output lines OL1 and OL2. The first load circuit 611a may be enabled in response to the first load control signal LD1 that is activated (for example, that has a power supply voltage, or a logic high value), and may be disabled in response to the first load control signal LD1 that is deactivated (for example, that has a voltage lower than a ground voltage or a threshold voltage of a transistor, or has a logic low value). Similarly, the second load circuit 621a may be enabled in response to the second load control signal LD2 that is activated, and may be disabled in response to the second load control signal LD2 that is deactivated. As will be described below with reference to FIG. 2B, the enabled first and second load circuits 611a and 621a may operate as current loads of amplifiers (i.e., source followers) included in the pixels 511, 512, 521, and 522 of the pixel array 500a, and may be formed of a transistor with a gate connected to receive the load control signal, and a current source. Also, the disabled first and second load circuits 611a and 621a may break a load current or provide a reduced load current.

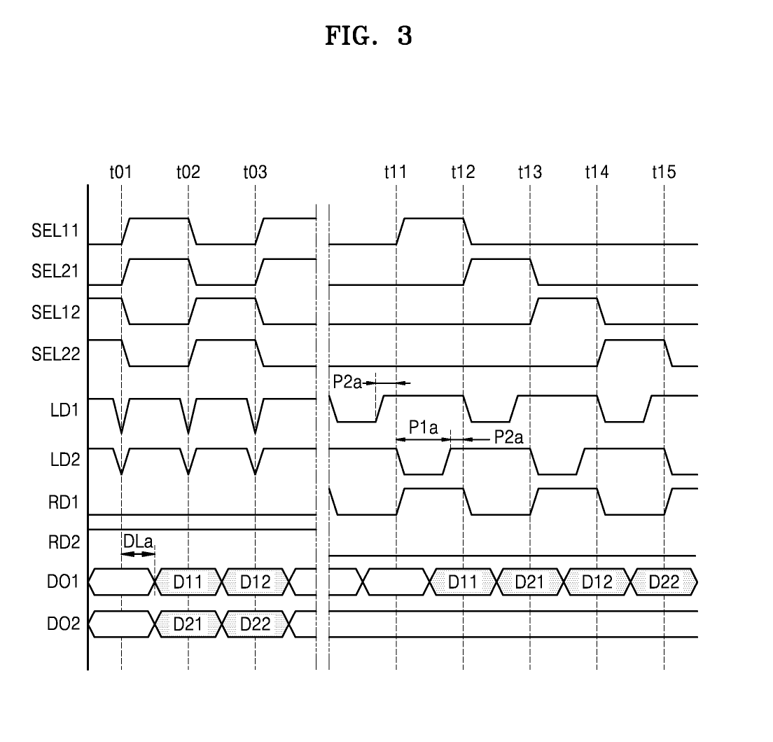

As described above with reference to FIG. 1, the column driver 400 of FIG. 1 may provide the first and second load control signals LD1 and LD2 such that the first and second load circuits 611a and 621a are all enabled in the high speed mode, and provide the first and second load control signals LD1 and LD2 such that at least one of the first and second load circuits 611a and 621a are enabled in the low speed mode. Details about the first and second load control signals LD1 and LD2 will be described below with reference to FIG. 3.

As shown in FIG. 2A, readout circuits 700a may receive first and second readout control signals RD1 and RD2 from among the readout control signals RDs provided from the column driver 400 of FIG. 1, and may output first and second digital output signals DO1 and DO2 from among the digital output signals DOs of FIG. 1. The readout circuits 700a may include a router 711a, may include an ADC 712a as a first readout circuit included in the first readout circuit group 710 of FIG. 1, and may include an ADC 721a as a second readout circuit included in the second readout circuit group 720 of FIG. 1.

The router 711a (or a routing circuit) may be connected to the first and second output lines OL1 and OL2, and output the first output signal PO1 and/or the second output signal PO2 according to the first and second readout control signals RD1 and RD2 (or routing signals). For example, the router 711a may provide the first output signal PO1 to the ADC 712a of the first readout circuit in response to the deactivated first readout control signal RD1, and provide the second output signal PO2 to the ADC 712a of the first readout circuit in response to the activated first readout control signal RD1. The ADC 712a of the first readout circuit may output the first digital output signal DO1 by converting an output signal of the router 711a. Similarly, the router 711a may provide the first output signal PO1 to the ADC 721a of the second readout circuit in response to the deactivated second readout control signal RD2, and provide the second output signal PO2 of the ADC 721a of the second readout circuit in response to the activated second readout control signal RD2. The ADC 721a of the second readout circuit may be enabled or disabled according to the first and second readout control signals RD1 and RD2. For example, the ADC 721a of the second readout circuit may be enabled in response to the first and second readout control signals RD1 and RD2 corresponding to the high speed mode, and may be disabled in response to the first and second readout control signals RD1 and RD2 corresponding to the low speed mode.

The column driver 400 of FIG. 1 may provide the first and second readout control signals RD1 and RD2 such that the router 711a provides the first and second output signals PO1 and PO2 respectively to the ADCs 712a and 721a in the high speed mode. On the other hand, the column driver 400 of FIG. 1 may provide the first and second readout control signals RD1 and RD2 such that the router 711a alternately provides the first and second output signals PO1 and PO2 to the ADC 712a of the first readout circuit in the low speed mode. Accordingly, in the low speed mode, the first and second output signals PO1 and PO2 may be converted by the ADC 712a of the first readout circuit. The first and second readout control signals RD1 and RD2 provided in each of the high and low speed modes will be described below with reference to FIG. 3. It should be noted that although FIG. 2A only shows one column of pixels, similar load circuits 600a and readout circuits 700a may be used that correspond to each column of pixels in the pixel array 500.

Referring to FIG. 2B, a pixel 511′ included in the first pixel group 510 and a pixel 521′ included in the second pixel group 520 may have the same structure. For example, the pixel 511′ included in the first pixel group 510 may receive a reset control signal RS11, a transmission control signal TG11, and the selection control signal SEL11, and output the first output signal PO1 to the first output line OL1. A photodiode PD1 may accumulate charges by detecting light. A second transistor M2 (or a reset transistor) may reset a voltage of a floating diffuser FD (for example, to a power supply voltage), in response to the activated reset control signal RS11. Then, A first transistor M1 (or a transmission transistor) may form a moving path of charges between the photodiode PD1 and the floating diffuser FD to change the voltage of the floating diffuser FD, in response to the activated transmission control signal TG11. The voltage of the floating diffusion FD may be amplified by a third transistor M3 (or a source follower), and a signal amplified by a fourth transistor M4 (or a selection transistor) in response to the activated selection control signal SEL11 may be output to the first output line OL1, as the first output signal PO1. A structure of a pixel shown in FIG. 2B is only an example, and an image sensor and a method of operating the image sensor, according to various embodiments, are not limited by the structure of FIG. 2B.

FIG. 3 is a timing diagram of signals of FIG. 2A according to passage of time, according to an embodiment. For example, FIG. 3 shows the signals according to the passage of time, while the first and second digital output signals DO1 and DO2 from among output signals output by the pixels 511, 512, 521, and 522 of FIG. 2A are output in each of the high and low speed modes. In FIG. 3, an activated signal has a high level and a deactivated signal has a low level, but the disclosure is not limited thereto. Hereinafter. FIG. 3 will be described with reference to FIGS. 1 and 2A.

Referring to FIG. 3, the first readout control signal RD1 may be deactivated and the second readout control signal RD2 may be activated from a time t01 to a time t03. In this example, the image sensor 10 may operate in the high speed mode from the time t01 to time t03, and accordingly, the router 711a may provide the first output signal PO1 of the first output line OL1 to the ADC 712a of the first readout circuit, and provide the second output signal PO2 of the second output line OL2 to the ADC 721a of the second readout circuit. Furthermore, the first readout control signal RD1 may be toggled and the second readout control signal RD2 may be deactivated from a time t11 to a time t15. In this case, from the time t11 to the time t15, the image sensor 10 may operate in the low speed mode, and accordingly, the router 711a may alternately output the first and second output signals PO1 and PO2 to the ADC 712a of the first readout circuit (while the ADC 721a of the second readout circuit may be disabled). Accordingly, as shown in FIG. 3, data D11 and D21 corresponding to output signals of the pixels 511 and 521 may be output in parallel through the first and second digital output signals DO1 and DO2 in the high speed mode, and may be output in series through the first digital output signal DO1 in the low speed mode. Similarly, data D12 and D22 corresponding to output signals of the pixels 512 and 522 may be output in parallel through the first and second digital output signals DO1 and DO2 in the high speed mode, and may be output in series through the first digital output signal DO1 in the low speed mode. Also, as shown in FIG. 3, in one embodiment the first and second output signals PO1 and PO2 are alternated every time in the low speed mode, but according to another embodiment, the pixels 511 and 512 may sequentially output the first output signal PO1, and then the pixels 521 and 522 may sequentially output the second output signal PO2.

At the time t01, the selection control signals SEL11 and SEL21 may be activated and selection control signals SEL12 and SEL22 may be deactivated. Also, the first and second load control signals LD1 and LD2 may be activated. Accordingly, the first and second output signals PO1 and PO2 may be output from the pixels 511 and 521 through the first and second output lines OL1 and OL2. When the first and second output signals PO1 and PO2 are converted, the first and second digital output signals DO1 and DO2 may respectively indicate the data D11 and D21 at a point in time when a certain period of time DLa is delayed after the time t01.

At the time t02, the selection control signals SEL12 and SEL22 may be activated, and the selection control signals SEL11 and SEL21 may be deactivated. For example, the selection control signals SEL11, SEL12, SEL21, and SEL22 may be reversed at the time t02. Also, the first and second load control signals LD1 and LD2 may be activated, and the first and second output signals PO1 and PO2 may be output from the pixels 512 and 522 through the first and second output lines OL1 and OL2. When the first and second output signals PO1 and PO2 are converted, the first and second digital output signals DO1 and DO2 may respectively indicate the data D12 and D22 at a point in time when a certain period of time is delayed from the time t02.

At the time t11, the selection control signal SEL11 may be activated and the other selection control signals SEL12, SEL21, and SEL22 may be deactivated. The first load control signal LD1 may be in an activated state so as to enable the first load circuit 611a such that the first output signal PO1 of the pixel 511 is output through the first output line OL1 during a first period (e.g., between t11 and t12). The first load control signal LD1 may be activated before the time t11 such that the first load circuit 611a is in a steady state at the time t11. For example, the first load control signal LD1 may be pre-activated such that the first output signal PO1 of the pixel 511 is normally output at the time t11 through the first output line OL1 in response to the activated selection control signal SEL11. For example, as shown in FIG. 3, the first load control signal LD1 may be activated at a point in time of a period P2a before the time t11, wherein a length of the period P2a may be pre-determined according to operation characteristics of the first load circuit 611a. As shown in FIG. 2A, when the first load circuit 611a includes a current source providing a current, and a switch (i.e., a transistor), a steady state of the first load circuit 611a may denote a state in which the switch is turned on and an output current of the current source has a pre-set size.

At the time t11, the second load control signal LD2 may be deactivated. In this example, the first load circuit 611a is enabled such that the first output signal PO1 of the pixel 511 is output through the first output line OL1, whereas the second load circuit 621a is disabled because the second output signal PO2 of the pixels 521 and 522 are blocked from being output through the second output line OL2 due to the deactivated selection control signals SEL21 and SEL22. As shown in FIG. 3, the second load control signal LD2 may be deactivated from the time t11 to a point of time after a period P1a, and then activated during a following period P2a. Unlike FIG. 3, when the second load control signal LD2 is activated during a period where the first output signal PO1 is output (i.e., from the time t11 to the time t12) for a normal output of the second output signal PO2 at the time t12, the second load circuit 621 may maintain an enabled state during the period where the first output signal PO1 is output. On the other hand, as shown in FIG. 3, when the second load control signal LD2 is deactivated during at least a part (i.e., the period P1a) of the period where the first output signal PO1 is output, power consumption generated by the second load circuit 621a may be removed. When the second load circuit group 620 included in the load circuits 600 of FIG. 1 is disabled during at least a part of a period where the first output signal group PO1s is output, power consumption generated by the enabled second load circuit group 620 (e.g., due to a current flowing through transistors of the load circuits of the second load circuit group) may be removed, and accordingly, power consumption of the image sensor 10 may be remarkably reduced in the low speed mode because of not only the disabled second readout circuit group 720, but also the disabled second load circuit group 620 as shown in FIG. 3. According to a test result, about 50% of power consumption is reduced.

At the time t12, for a second period, the selection control signal SEL21 is activated and the remaining selection control signals SEL11, SEL12, and SEL22 are deactivated. The first load control signal LD1 may be deactivated so as to disable the first load circuit 611a, and the second load control signal LD2 may be in an activated state. Similarly to the first load control signal LD1 described above, the second load control signal LD2 may be pre-activated such that the second output signal PO2 of the pixel 521 is normally output at the time t12 through the second output line OL2 in response to the activated selection control signal SEL21. For example, the second load control signal LD2 may be activated for a third period (shown as P2a) shorter than the first period (e.g., the period between t11 and t12) and during the first period (e.g., before the first period ends), in order to enable the second load circuit 621a prior to activation of the selection control signal SEL21. The third period may be equal to or longer than a time needed for the second load circuit 621a and the second load circuit group 620 to reach a steady state. In connection with the current sources and switches described above, the third period ay be equal to or longer than a time needed for an output current of each current source to reach a pre-set size as the switch is turned on according to the first and second respective load control signals.

At the time t13, the selection control signal SEL12 is activated and the remaining selection control signals SEL11, SEL21, and SEL22 are deactivated. Similarly to the time t11, the first load control signal LD1 may be activated before the time t13 and maintain an activated state so as to enable the first load circuit 611a such that the first output signal PO1 of the pixel 512 is output through the first output line OL1. Also, the second load control signal LD2 may be deactivated, and may be pre-activated before the time t14.

At the time t14, the selection control signal SEL22 is activated and the remaining selection control signals SEL11, SEL12, and SEL21 are deactivated. Similarly to the time t12, the second load control signal LD2 may be pre-activated before the time t14 and maintain an activated state so as to enable the second load circuit 621a such that the second output signal PO2 of the pixel 522 is output through the second output line OL2. Also, the first load control signal LD1 may be deactivated and may be pre-activated before the time t15.

Thus, the above image sensor 10 supports a method that includes a low speed mode and a high speed mode for a pixel array having a plurality of rows of pixels. During a first time period of the low speed mode, a first load circuit connected to a first output line connected to a plurality of pixels in a first column of the pixel array is enabled, pixel data from a first pixel in a first row and the first column of the pixel array is output, and a second load circuit connected to a second output line connected to a plurality of pixels in a second column of the pixel array is disabled. During a second time period different from the first time period, the second load circuit connected to the second output line is enabled, pixel data from a second pixel in a second row and the second column of the pixel array is output, and the first load circuit is disabled. During a high speed mode the first load circuit and the second load circuit are simultaneously enabled in order to output pixel data from the first pixel simultaneously with outputting pixel data from the second pixel. In addition, during the low speed mode, during a third time period after the first and second time periods, the first load circuit may be enabled, pixel data from a first pixel in a third row and the first column of the pixel array may be output, and the second load circuit may be disabled. During a fourth time period after the third time period, the second load circuit may be enabled, pixel data from a first pixel in a fourth row and the second column of the pixel array may be output, and the first load circuit may be disabled. Further, during the high speed mode, the first load circuit and the second load circuit may be simultaneously enabled in order to output pixel data from the third pixel simultaneously with outputting pixel data from the fourth pixel.

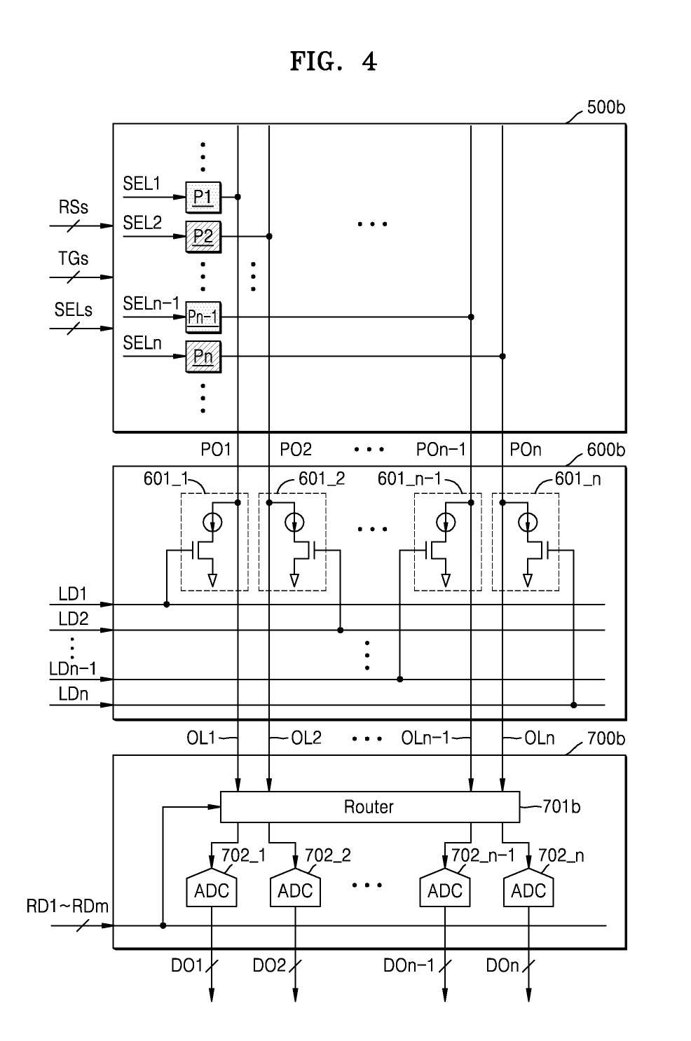

FIG. 4 is a block diagram of some pixels of the pixel array 500 of FIG. 1, and circuits related to the pixels, according to an embodiment. Comparing FIG. 4 and FIG. 2A, pixels disposed on one column of a pixel array 500b of FIG. 4 may be each be connected to one of n lines, wherein n is an integer equal to or higher than 4. In this manner, the pixel array 500b may include first through n^{th} pixel groups, and pixels P1 through Pn respectively included in the first through n^{th} pixel groups may be respectively connected to first through n^{th} output lines OL1 through OLn. Accordingly, load circuits 600b may include first through n^{th} load circuits 601_1 through 601_n, i.e., first through n^{th} load circuit groups, which correspond to one column of the pixel array 500b. Also, readout circuits 700b may include first through n^{th} ADCs 702_1 through 702_n, i.e., first through n^{th} readout circuit groups, which correspond to one column of the pixel array 500b. Descriptions of FIG. 4 overlapping those of FIGS. 2A and 2B will not be provided again, and FIG. 4 will be described with reference to FIG. 1.

The load circuits 600b may include the first through n^{th} load circuits 601_1 through 601_n respectively included in the first through n^{th} load circuit groups. The first through n^{th} load circuits 601_1 through 601_n may be respectively connected to the first through n^{th} output lines OL1 through OLn. The first through n^{th} load circuits 601_1 through 601_n may be enabled respectively in response to activated first through n^{th} load control signals LD1 through LDn, and disabled respectively in response to the deactivated first through n^{th} load control signals LD1 through LDn.

The readout circuits 700b may output first through n^{th} digital output signals DO1 through DOn from among the digital output signals DOs of FIG. 1. Comparing with FIG. 2A, n digital output signals may be output form one column of the pixel array 500b. Therefore, the high speed mode of FIG. 4 may support a faster operation speed than the high speed mode of FIG. 2A.

The readout circuits 700b may include a router 701b, and may include the first through n^{th} ADCs 702_1 through 702_n as first through n^{th} readout circuits respectively included in first through n^{th} readout circuit groups. The router 701b may be connected to the first through n^{th} output lines OL1 through OLn. The router 701b may provide first through n^{th} output signals PO1 through POn to the first through n^{th} ADCs 702_1 through 702_n in response to first through m^{th} readout control signals RD1 through RDm, wherein m is an integer equal to or higher than 3.

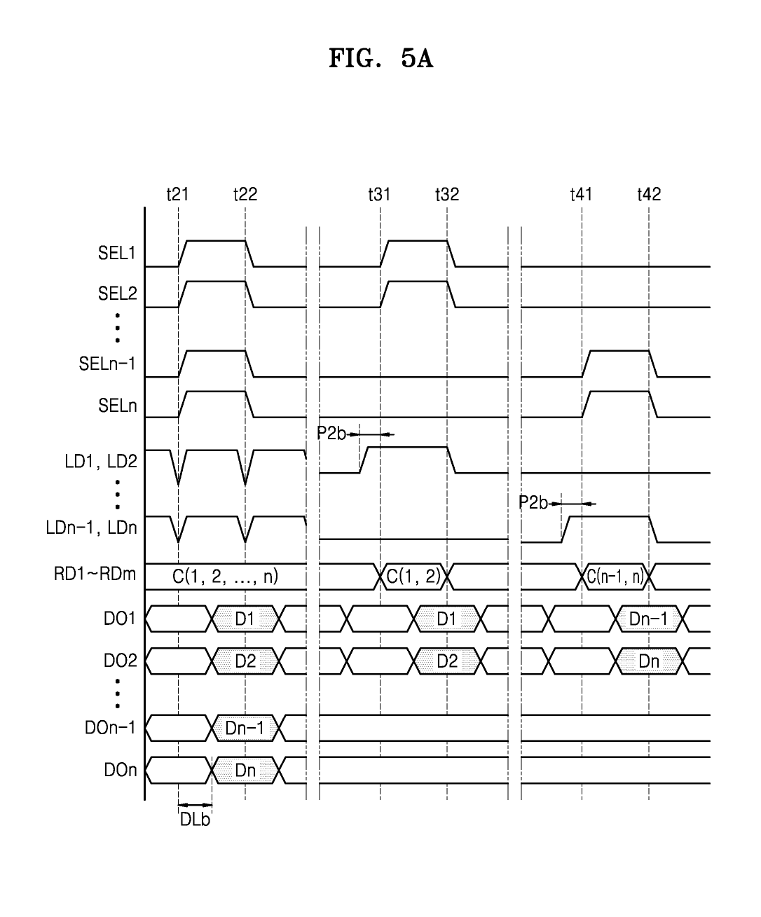

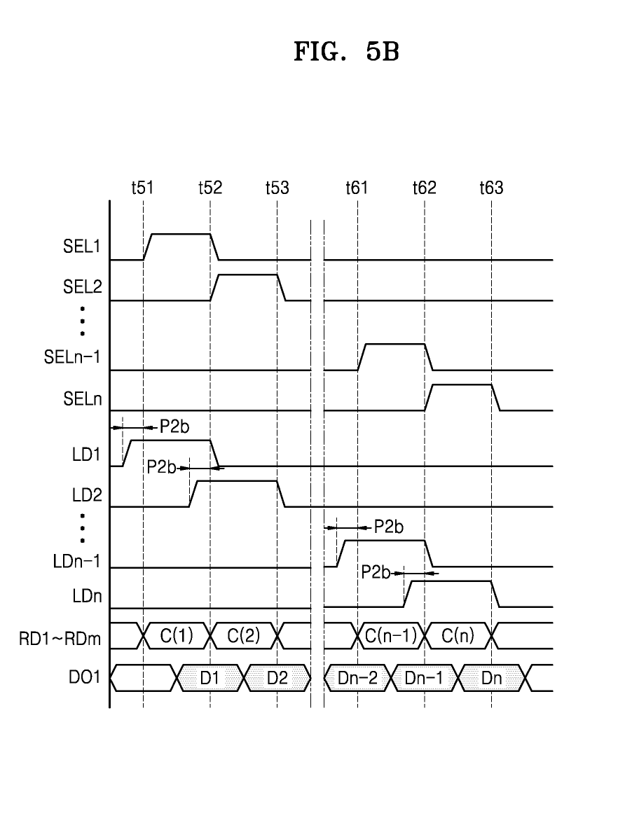

FIGS. 5A and 5b are timing diagrams of signals of FIG. 4 according to passage of time, according to certain embodiments. For example, FIG. 5A shows the signals according to the passage of time, while the first through n^{th} digital output signals DO1 and DOn from among output signals output by the first through n^{th} pixels P1 through Pn of FIG. 4 are output in each of the high and low speed modes. Also, FIG. 5B shows the signals according to the passage of time, while the first through n^{th} digital output signals DO1 through DOn from among output signals output by the first through n^{th} pixels P1 through Pn of FIG. 4 are output in a low speed mode (for example, a sleep mode) having an operation speed slower than that of the low speed mode of FIG. 5A. The low speed mode of FIG. 5B may be referred to as a second low speed mode, whereas the low speed mode of FIG. 5A may be referred to as first low speed mode. Descriptions of FIGS. 5A and 5B, which overlap those of FIG. 3 will not be provided again, and FIGS. 5A and 5B will be described with reference to FIGS. 1 and 4.

Referring to FIG. 5A, the image sensor 10 may operate in the high speed mode from a time t21 to a time 22, and the first through m^{th} readout control signals RD1 through RDm may have codes C(1) through C(n) enabling the first through n^{th} output signals PO1 through POn to be respectively provided to the first through n^{th} ADCs 702_1 through 702_n. Meanwhile, the image sensor 10 may operate in the low speed mode from a time t31 through a time t42, and the first through m^{th} readout control signals RD1 through RDm may sequentially have codes (for example, C(1,2), C(3,4) and so on) enabling output respective signal pairs from among the first through n^{th} output signals PO1 through POn to be sequentially output to the first and second ADCs 702_1 and 702_2. Accordingly, as shown in FIG. 5A, pieces of data D1 through Dn corresponding to the output signals of the first through n^{th} pixels P1 through Pn may be output in parallel through the first through n^{th} digital output signals DO1 through DOn in the high speed mode, and may be output in parallel through the first and second digital output signals DO1 and DO2 in the low speed mode. Although FIG. 5A shows an example of two digital output singles simultaneously output in the low speed mode, but more than two digital output signals (for example, four digital output signals) may be simultaneously output in the low speed mode.

At the time t21, first through n^{th} selection control signals SEL1 through SELn may be activated, and the first through n^{th} load control signals LD1 through LDn may be activated. Accordingly, the first through n^{th} output signals PO1 through POn may be respectively output through the first through n^{th} output lines OL1 through OLn from the first through n^{th} pixels P1 through Pn. When the first through n^{th} output signals PO1 through POn are converted, the pieces of data D1 through Dn may be output at a point in time when a certain period of time DLb is delayed from the time t21.

At the time t31, the first and second selection control signals SEL1 and SEL2 may be activated and remaining selection control signals may be deactivated. The first and second load control signals LD1 and LD2 may be in activated states so as to enable first and second load circuits 601_1 and 601_2 such that the first and second output signals PO1 and PO2 of the pixels P1 and P2 are output respectively through the first and second output lines OL1 and OL2. As described above with reference to FIG. 3, the first and second load control signals LD1 and LD2 may be pre-activated at a point of time of a period P2b before the time t31 such that the first and second load circuits 601_1 and 601_2 are in steady states at the time t31. Selection control signals excluding the first and second load control signals LD1 and LD2 may be in deactivated states, and accordingly, power consumption of load circuits excluding the first and second load circuits 601_1 and 601_2 may be reduced or removed. The first through m^{th} readout control signals RD1 through RDm may have a code C(1,2) such that the first and second output signals PO1 and PO2 are respectively provided to the first and second ADCs 702_1 and 702_2.

At the time t32, the first and second selection control signals SEL1 and SEL2 may be deactivated. Also, the first and second load control signals LD1 and LD2 may be deactivated so as to disable the first and second load circuits 601_1 and 601_2.

At the time t41, the n−1^{th} and n^{th} selection control signals SELn−1 and SELn may be activated, and remaining selection control signals may be deactivated. The n−1^{th} and n^{th} load control signals may be pre-activated at a point of time of the period P2b before the time t41. The first through m^{th} readout control signals RD1 through RDm may have a code C(n−1,n) such that the n−1^{th} and n^{th} output signals POn−1 and POn are respectively provided to the n−1^{th} and n^{th} ADCs 702_n−1 and 702_n.

Though FIG. 5A shows a low speed mode (e.g., first low speed mode) where rows of pixels are selected in pairs and are output simultaneously, this is merely one example. The pixel rows in the low speed mode can be selected in groups of three or four or other amounts, or even individually. For example, referring to FIG. 5B, the image sensor 10 may operate in a second low speed mode (for example, a sleep mode) having an operation speed slower than that of the first low speed mode of FIG. 5A, and the first through m^{th} readout control signals RD1 through RDm may have codes (for example, C(1), C(2), and so on) such that the first through n^{th} output signals PO1 through POn are sequentially provided to the first ADC 702_1. Accordingly, the pieces of data D1 through Dn corresponding to the output signals of the first through n^{th} pixels P1 through Pn may be output through the first digital output signal DO1 in series.

At the time t51, the first selection control signal SEL1 may be activated and remaining selection control signals may be deactivated. The first load control signal LD1 may be pre-activated at a point of time of the period P2b before the time t51 so as to enable the first load circuit 601_1 such that the first output signal PO1 of the pixel P1 is output through the first output line OL1. Load control signals excluding the first load control signal LD1 may be in deactivated states, and accordingly, power consumption of load circuits excluding the first load circuit 601_1 may be reduced or removed. The first through m^{th} readout control signals RD1 through RDm may have a code C(1) such that the first output signal PO1 is provided to the first ADC 702_1.

At each of the times t52, t53, t61, and t62, one of the first through n^{th} selection control signals SEL1 through SELn may be activated and remaining selection control signals may be deactivated, similarly to the time t51. Also, one of the first through n^{th} load control signals LD1 through LDn may be pre-activated, and remaining load control signals may be in deactivated states. Accordingly, power consumption of the first through n^{th} load circuits 601_1 through 601_n in the low speed mode of FIG. 5B may be reduced.

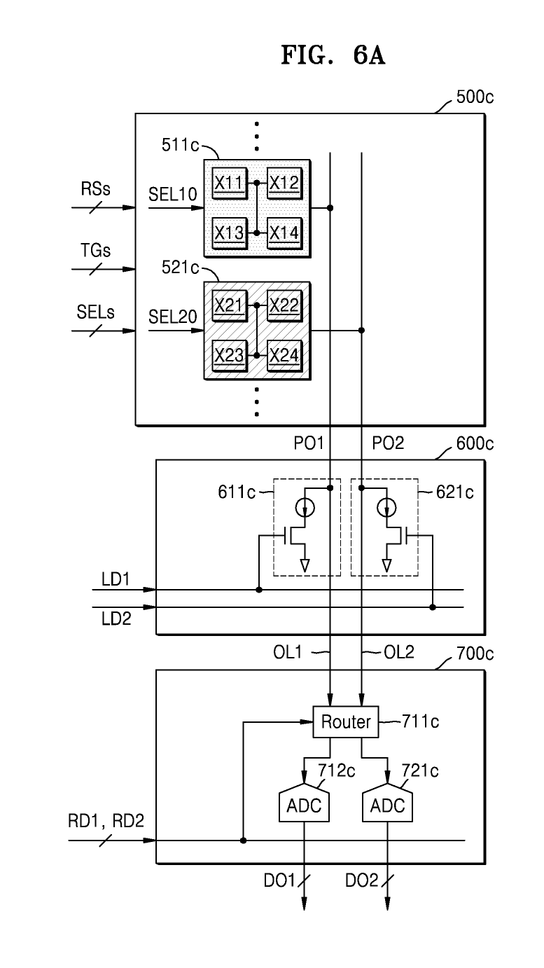

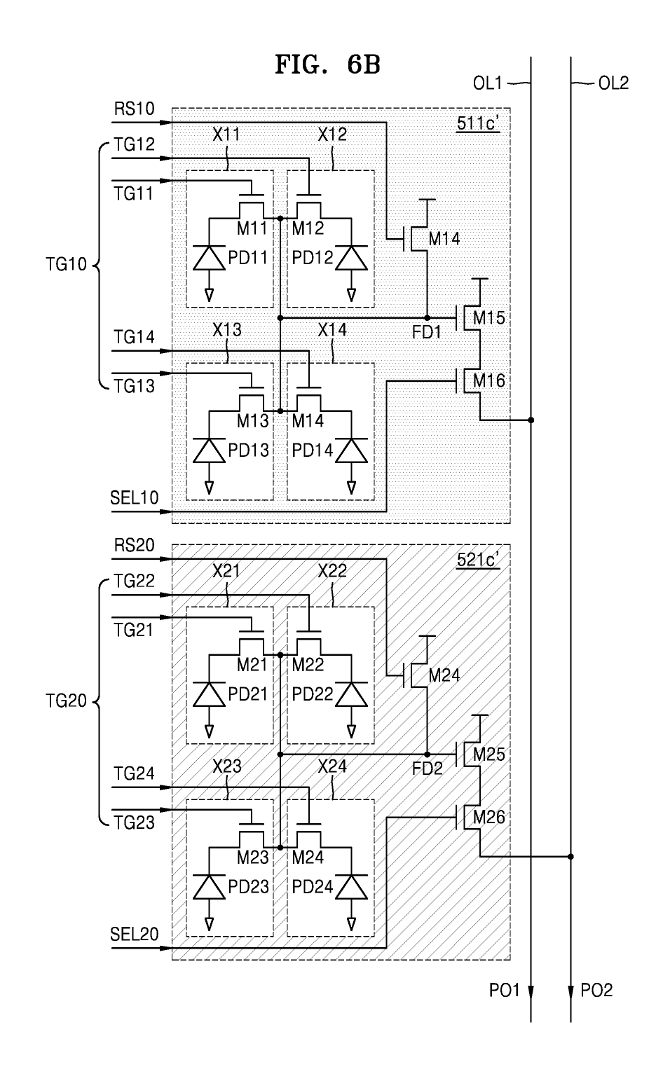

FIG. 6A is a block diagram of some pixels of the pixel array 500 of FIG. 1, and circuits related to the some pixels, according to an embodiment, and FIG. 6B is a circuit diagram of examples of shared-pixels 511c and 512c of FIG. 6A. Compared with FIG. 2A, a pixel array 500c of FIG. 6A may include a shared-pixel (for example, the shared-pixel 511c) including a plurality of pixels (for example, sub-pixels X11 through X14) sharing at least one device, and wherein each of the first and second pixel groups 510 and 520 of FIG. 1 may include a plurality of shared-pixels. Descriptions of FIGS. 6A and 6B, which overlap those of FIGS. 2A and 2B, will not be provided again, and FIGS. 6A and 6B will be described with reference to FIG. 1.

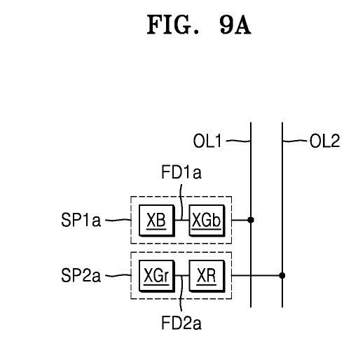

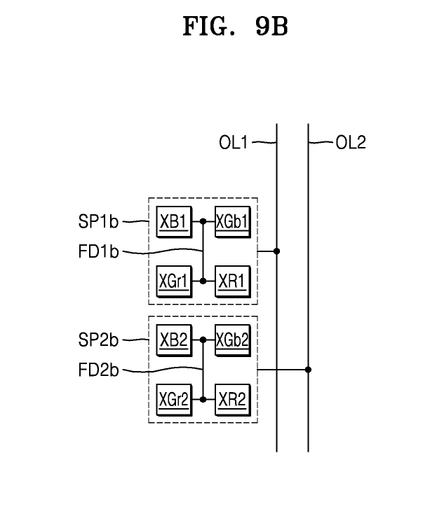

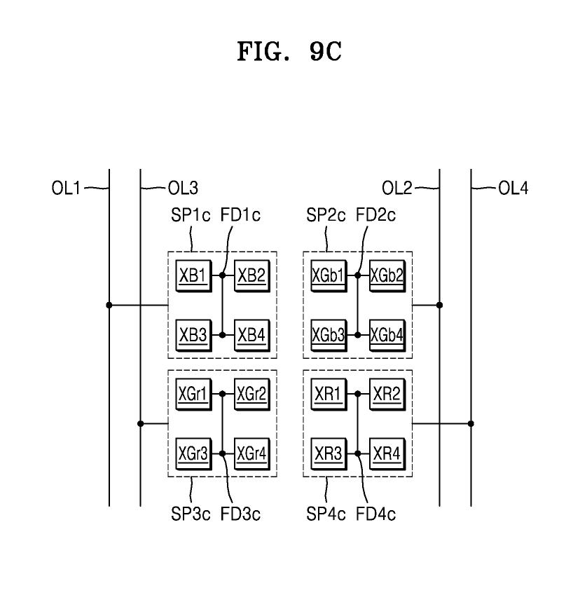

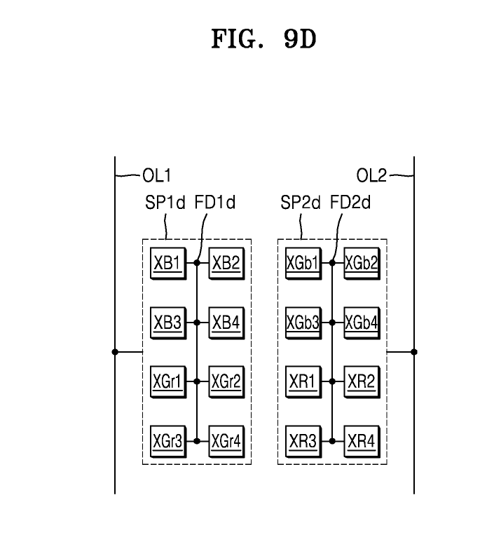

Referring to FIG. 6A, in the pixel array 500c, the shared-pixel 511c of the first pixel group 510 may include the sub-pixels X11 through X14, and be connected to the first output line OL1. Also, the shared-pixel 521c of the second pixel group 520 may include sub-pixels X21 through X24, and be connected to the second output line OL2. According to an embodiment, the sub-pixels X11 through X14 included in the shared-pixel 511c may correspond to a Bayer pattern, or may correspond to the same color as shown in FIG. 9C. According to an embodiment, shared-pixels disposed on the same column from among shared-pixels of the first pixel group 510 may be connected to the same output line, and shared-pixels disposed on the same column from among shared-pixels of the second pixel group 520 may be connected to the same output line.

Each of the shared-pixels 511c and 521c may receive one of the selection control signals SELs provided from the row driver 300 of FIG. 1, and output an output signal to an output line in response to a received selection control signal. For example, the shared-pixel 511c of the first pixel group 510 may receive a selection control signal SEL10, and output the first output signal PO1 corresponding to an electric signal generated when one of the sub-pixels X11 through X14 detects light, through the first output line OL1 in response to the activated selection control signal SEL10. Similarly, the shared-pixel 521c of the second pixel group 520 may receive a selection control signal SEL20, and output the second output signal PO2 corresponding to an electric signal generated when one of the sub-pixels X21 through X24 detects light, through the second output line OL2 in response to the activated selection control signal SEL20. Details about a shared-pixel will be described below with reference to FIG. 5B.

Load circuits 600c may include a first load circuit 611c included in the first load circuit group 610 of FIG. 1, and a second load circuit 621c included in the second load circuit group 620 of FIG. 1. The first and second load circuits 611c and 621c may be respectively connected to the first and second output lines OL1 and OL2, and may respectively receive the first and second load control signals LD1 and LD2.

Readout circuits 700c may include a router 711c, may include an ADC 712c as a first readout circuit included in the first readout circuit group 710 of FIG. 1, and may include an ADC 721c as a second readout circuit included in the second readout circuit group 720 of FIG. 1. The router 711c may be connected to the first and second output lines OL1 and OL2, and may output the first output signal PO1 and/or the second output signal PO2 according to the first and second readout control signals RD1 and RD2.

Referring to FIG. 6B, a shared-pixel 511c′ included in the first pixel group 510 and a shared-pixel 521c′ included in the second pixel group 520 may have the same structure. For example, the shared-pixel 511c′ may receive a reset control signal RS10, transmission control signals TG11 through TG14, and the selection control signal SEL10, and output the first output signal PO1 through the first output line OL1. As shown in FIG. 6B, the sub-pixels X11 through X14 included in the shared-pixel 511c′ may share a reset transistor M14, a source follower M15, and a selection transistor M16. The sub-pixels X11 through X14 may respectively include photodiodes PD11 through PD14 and respectively include transmission transistors M11 through M14, and may transfer charges accumulated by detecting light to a first floating diffuser FD1 in response to the activated transmission control signals TG11 through TG14. The row driver 300 of FIG. 1 may activate the selection control signal SEL10, and sequentially activate and deactivate the transmission control signals TG11 through TG14. Signals generated by the sub-pixels X11 through X14 included in the shared-pixel 511c′ may be sequentially output through the first output line OL1, as the first output signal PO1. As shown in FIG. 6B, a structure in which 4 sub-pixels share at least one device may be referred to as a 2-by-2 shared-pixel structure. A structure of a shared-pixel shown in FIG. 6B is only an example, and an image sensor and a method of operating the same, according to one or more embodiments, are not limited by the structure of FIG. 6B. For example, according to an embodiment, the sub-pixels X11 through X14 of the shared-pixel 511c′ may only share the source follower M15 and the selection transistor M16. According to an embodiment, a sub-pixel may include two separate photodiodes. For example, unlike FIG. 6B, the sub-pixel X1 may include two photodiodes connected to the transmission transistor M11.

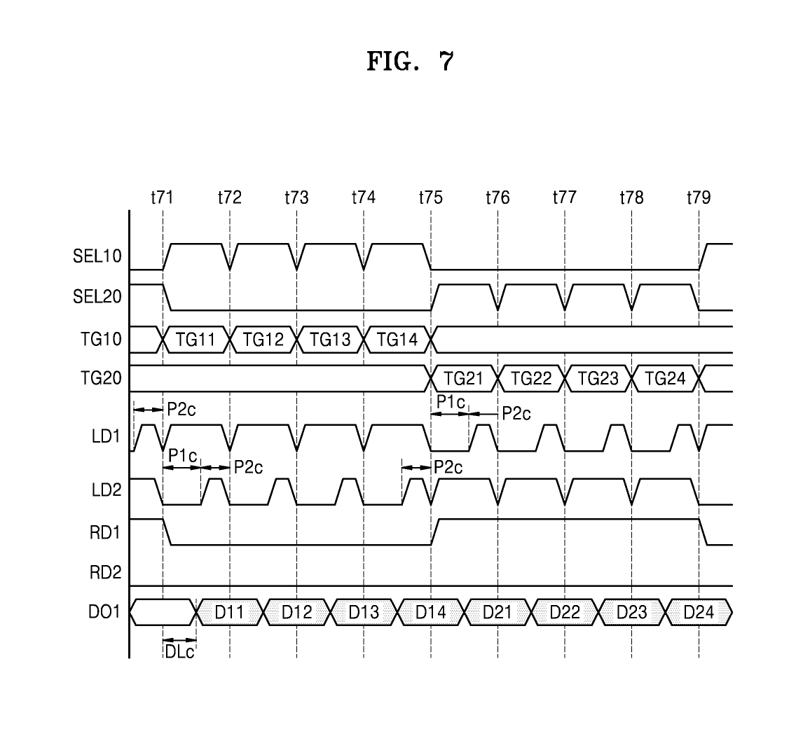

FIG. 7 is a timing diagram of signals of FIG. 6A according to passage of time, according to an embodiment. For example, FIG. 7 shows the signals according to the passage of time, while the first digital output signal DO1 is output from output signals corresponding to signals generated by the sub-pixels X11 through X14 and X21 through X24 of FIG. 6A in the low speed mode. Descriptions of FIG. 7, which overlap those of FIG. 3, will not be provided again, and FIG. 7 will be described with reference to FIGS. 1 and 6A.

Referring to FIG. 7, the first readout control signal RD1 may be toggled and the second readout control signal RD2 may be deactivated from a time t71 to a time t79. For example, from the time t71 to the time t79, the image sensor 10 may operate in the low speed mode, and the router 711c may alternately provide the first and second output signals PO1 and PO2 to the ADC 712c of the first readout circuit. Accordingly, pieces of data D11 through D14 and D21 through D24 corresponding to the sub-pixels X11 through X14 and X21 through X24 may be output through the first digital output signal DO1 in series, as a first sequence of output signals, each output in a sub-period of a series of sub-periods included in the first period when reading the first digital output signal D01. Although not shown in FIG. 7, the pieces of data D11 through D14 and D21 through D24 corresponding to the sub-pixels X11 through X14 and X21 through X24 may be output through the first and second digital output signals DO1 and DO2 in parallel, in the high speed mode.

At the time t71, the selection control signal SEL10 may be activated and the selection control signal SEL20 may be deactivated, Also, the transmission control signal TG11 provided to the sub-pixel X11 from among transmission control signals TG10 provided to the shared-pixel 511c may be activated, and the first load control signal LD1 may be activated. Accordingly, the first output signal PO1 corresponding to the sub-pixel X11 may be output from the shared-pixel 511c through the first output line OL1. When the first output signal PO1 is converted, the data D11 may be output at a point in time when a certain period of time DLc is delayed from the time t71. As described above with reference to FIG. 3, the first load control signal LD1 may be pre-activated at a point of time of a period P2c before the time t71 such that the first load circuit 611c is in a steady state at the time t71.

At the time t71, the second load control signal LD2 may be deactivated. Therefore, the second load circuit 621c may be disabled since the second output signal PO2 of the shared-pixel 521c is blocked from being output through the second output line OL2 due to the deactivated selection control signal SEL20. For example, the second load control signal LD2 may be deactivated during a period P1c after the time t71 and then activated during a following period P2c.

At the time t72 through t74, transmission control signals TG12 through TG14 respectively provided to the sub-pixels X12 through X14, from among the transmission control signals TG10 provided to the shared-pixel 511c, may be sequentially activated and deactivated. As shown in FIG. 7, the second load control signal LD2 may be toggled, such that the second load circuit group is enabled after being disabled in each sub-period of the series of sub-periods, and accordingly, power consumption generated by the second load circuit 621c may be reduced. The enabling and disabling may each occur for a partial sub-period.

At the time t75, the selection control signal SEL10 may be deactivated, and the selection control signal SEL20 may be activated. Also, a transmission control signal TG21 provided to the sub-pixel X21 from among transmission control signals TG20 provided to the shared-pixel 521c may be activated, and the second load control signal LD2 may be activated. Accordingly, the second output signal PO2 may be output from the shared-pixel 521c through the second output line OL2. The second load control signal LD2 may be pre-activated at a point in time of a period P2c before the time t75 such that the second load circuit 621c is in a steady state at the time t75.

At the time t75, the first load control signal LD1 may be deactivated. Therefore, the first load circuit 611c may be disabled since the first output signal PO1 of the shared-pixel 511c is blocked from being output through the first output line OL1 due to the deactivated selection control signal SEL10. For example, the first load control signal LD1 may be deactivated during the period P1c after the time t75 and activated during the following period P2c.

From the time t76 to time t78, transmission control signals T22 through T24 respectively provided to the sub-pixels X22 through X24 from among the transmission control signals TG20 provided to the shared-pixel 521c may be sequentially activated and deactivated. As shown in FIG. 7, the first load control signal LD1 may be toggled, and accordingly, power consumption generated by the first load circuit 611c may be reduced.

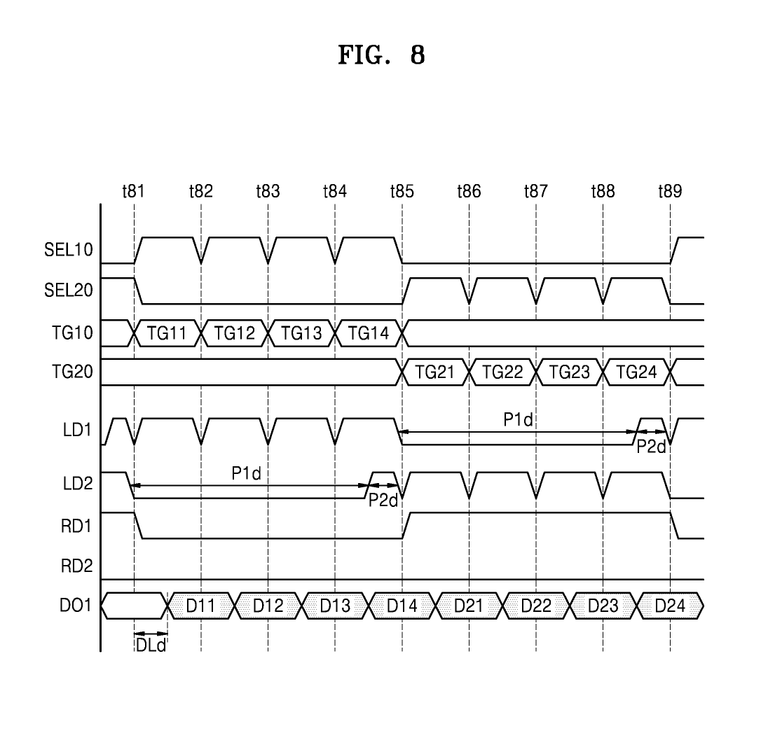

FIG. 8 is a timing diagram of signals of FIG. 6A according to passage of time, according to another embodiment. For example, FIG. 8 shows the signals according to the passage of time, while the first digital output signal DO1 is output from output signals corresponding to signals generated by the sub-pixels X11 through X14 and X21 through X24 of FIG. 6A, in the low speed mode. Compared with FIG. 7, periods where the first and second load control signals LD1 and LD2 are deactivated in FIG. 8 may include continuous deactivation. Descriptions of FIG. 8, which overlap those of FIG. 7, will not be provided again, and FIG. 8 will be described with reference to FIGS. 1 and 6A.

Referring to FIG. 8, at a time t81 through t89, the image sensor 10 may operate in the low speed mode, and in this regard, the first readout control signal RD1 may be toggled and the second readout control signal RD2 may be deactivated. Accordingly, as shown in FIG. 8, the pieces of data D11 through D14 and D21 through D24 corresponding to the sub-pixels X11 through X14 and X21 through X24 may be output in series through the first digital output signal DO1.

At the time t81, the selection control signal SEL10, the transmission control signal TG11, and the first load control signal LD1 may be activated in order to output the first output signal PO1 corresponding to the sub-pixel X11 of the shared-pixel 511c. Since the second output signal PO2 of the shared-pixel 521c is blocked from being output, the second load control signal LD2 may be deactivated. As shown in FIG. 8, the second load control signal LD2 may be deactivated in periods (i.e., from the time t81 through the time t84) where first output signals corresponding to the sub-pixels X11 through X13 of the shared-pixel 511c are sequentially output, and activated in periods (i.e., from the time t84 to the time t85) where a first output signal corresponding to the sub-pixel X14 of the shared-pixel 511c is output. Thus, the second load control signal LD2 may be continuously deactivated during a period P1d and activated during a period P2d.

As described above with reference to FIGS. 3, 5, and 7, the second load control signal LD2 may be pre-activated such that the second output signal PO2 of a pixel (or a shared-pixel) included in the second pixel group 520 is normally output after the first output signal PO1 of a pixel (or a shared-pixel) included in the first pixel group 510 is output. As shown in FIG. 6A, when output signals corresponding to sub-pixels included in one shared-pixel are sequentially output, a load circuit related to another shared-pixel may be enabled to be in a steady state before output signals corresponding to sub-pixels included in the other shared-pixel are sequentially output. Accordingly, instead of repeatedly toggling the second load control signal LD2 from the time t71 through the time t75 of FIG. 7, the second load control signal LD2 may be toggled once from the time t81 through the time t85 as shown in FIG. 8. The period P2d where the second load control signal LD2 is activated in FIG. 8 may be a period of time required for the second load circuit 621c to be in a steady state at the time t85, and may be equal to or longer than the period P2c of FIG. 7.

At the time t85, the first load control signal LD1 may be deactivated, and may maintain a deactivated state (e.g., be continuously deactivated) during the period P1d. Also, the first load control signal LD1 may be activated at a point of time of the period P2d before the time t89.

FIGS. 9A through 9D are block diagrams of some pixels of the pixel array 500 of FIG. 1, according to embodiments. In FIGS. 9A through 9D, pixels may be arranged in Bayer pattern units, and as described above with reference to FIGS. 6A and 6B, at least two adjacent pixels may share a floating diffuser. As such, a pixel unit including pixels (or sub-pixels) sharing a floating diffuser may be referred to as a shared-pixel. However, one or more embodiments may be applied to a shared-pixel different from those shown in FIGS. 9A through 9D. Also, shared-pixels are connected to different output lines in FIGS. 9A through 9D, but alternatively, shared-pixels disposed in different rows may be connected to the same output line.

Referring to FIG. 9A, according to an embodiment, a shared-pixel may include two pixels sharing a floating diffuser, and two sharing-pixels may form one Bayer pattern. For example, as shown in FIG. 9A, a shared-pixel SP1a connected to the first output line OL1 may include pixels XB and XGb respectively corresponding to blue and green and sharing a first floating diffuser FD1a. Also, a shared-pixel SP2a connected to the second output line OL2 may include pixels XGr and XR respectively corresponding to green and red and sharing a second floating diffuser FD2a. The shared-pixel shown in FIG. 9A may also be referred to as a 2-by-1 shared-pixel.

Referring to FIG. 9B, according to an embodiment, a shared-pixel may include four pixels sharing a floating diffuser and forming a Bayer pattern. For example, as shown in FIG. 9B, a shared-pixel SP1b connected to the first output line OL1 may include four pixels XB1, XGb1, XGr1, and XR1 sharing a first floating diffuser FD1b and forming a Bayer pattern. Also, a shared-pixel SP2b connected to the second output line OL2 may include four pixels XB2, SGb2, XGr2, and XR2 sharing a second floating diffuser FD2b and forming a Bayer pattern. The shared-pixel shown in FIG. 9B may also be referred to as a 2-by-2 shared-pixel.

Referring to FIG. 9C, according to an embodiment, a shared-pixel may include a plurality of pixels corresponding to one color. For example, as shown in FIG. 9C, a shared-pixel SP1c connected to the first output line OL1 may include four pixels XB1 through XB4 corresponding to blue and sharing a first floating diffuser FD1c, a shared-pixel SP2c connected to the second output line OL2 may include four pixels XGb1 through SGb4 corresponding to green and sharing a second floating diffuser FD2c, a shared-pixel SP3c connected to the third output line OL3 may include four pixels XGr1 through XGr4 corresponding to green and sharing a third floating diffuser FD3c, and a shared-pixel SP4c connected to the fourth output line OL4 may include four pixels XR1 through XR4 corresponding to red and sharing a fourth floating diffuser FD4c.

Referring to FIG. 9D, according to an embodiment, a shared-pixel may include eight pixels sharing a floating diffusion, wherein two shared-pixels form one Bayer pattern. For example, as shown in FIG. 9D, a shared-pixel SP1d connected to the first output line OL1 may include four pixels XB1 through XB4 corresponding to blue and four pixels XGr1 through XGr4 corresponding to green, wherein the pixels XB1 through XB4 and XGr1 through XGr4 may share a first floating diffuser FD1d. Also, a shared-pixel SP2d connected to the second output line OL2 may include four pixels XGb1 through XGb4 corresponding to green and four pixels XR1 through XR4 corresponding to red, wherein the pixels XGb1 through XGb4 and XR1 through XR4 may share a second floating diffuser FD2d. The shared-pixel shown in FIG. 9D may also be referred to as a 2-by-4 shared-pixel.

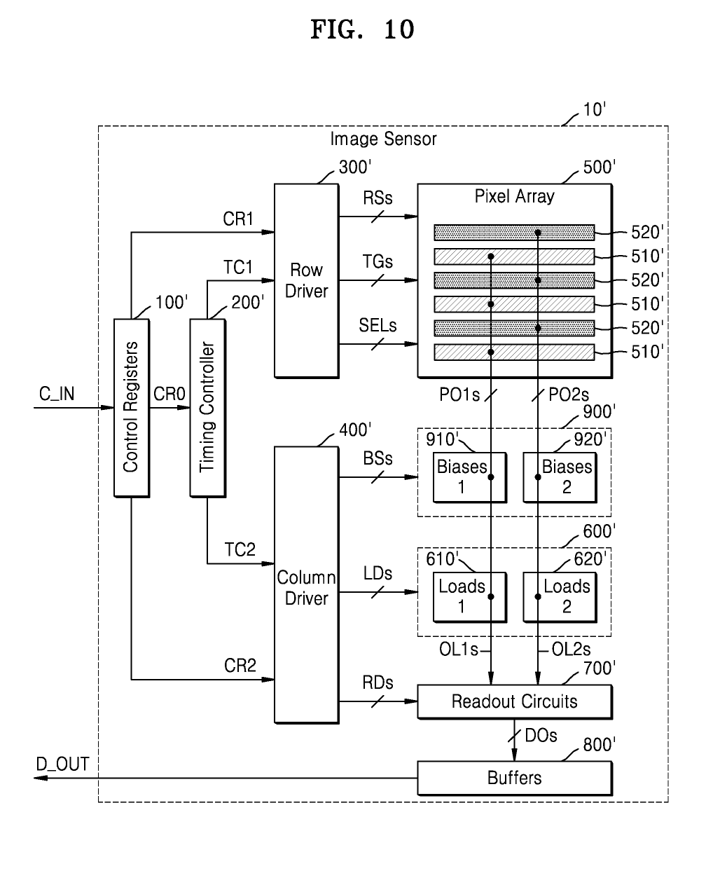

FIG. 10 is a block diagram of an image sensor 10′ according to another embodiment. As shown in FIG. 1, the image sensor 10′ may include control registers 100′, a timing controller 200′, a row driver 300′, a column driver 400′, a pixel array 500′, load circuits 600′, readout circuits 700′, buffers 800′, and bias circuits 900′. Compared with the image sensor 10 of FIG. 1, the image sensor 10′ of FIG. 10 may further include the bias circuits 900′, and the column driver 400′ may provide bias control signals BSs to the bias circuits 900′. The control registers 100′, the timing controller 200′, the row driver 300′, the column driver 400′, the pixel array 500′, the load circuits 600′, the readout circuits 700′, and the buffers 800′ of FIG. 10 may perform operations same as or similar to those of corresponding components of the image sensor 10 of FIG. 1.

The bias circuits 900′ may provide bias voltages to the first and second output line groups OL1s and OL2s. For example, as shown in FIG. 10, the bias circuits 900′ may be connected to the first and second output line groups OL1s and OL2s, and may bias the first and second output line groups OL1s and OL2s to a certain voltage (for example, a power supply voltage) during a period where the first and second output signal groups PO1s and PO2s are not output through the first and second output line groups OL1s and OL2s. Accordingly, noise that may be generated when the first and second output line groups OL1s and OL2s float or when an arbitrary signal is applied may be removed. As shown in FIG. 10, the bias circuits 900′ may include a first bias circuit group 910′ connected to the first output line group OL1s and a second bias circuit group 920′ connected to the second output line group OL2s. The first and second bias circuit groups 910′ and 920′ may be enabled or disabled based on the bias control signals BSs provided by the column driver 400′.

The column driver 400′ may generate the bias control signals BSs such that at least a part of the bias circuits 900′ biases an output line group that does not output an output signal. For example, the column driver 400′ may generate the bias control signals BSs such that, when first output signals corresponding to different rows are sequentially output through the first output line group OL1s, the first bias circuit group 910′ biases the first output line group OL1s between periods where the first output signals are output in a high speed mode. Also, the column driver 400′ may generate the bias control signals BSs such that the second bias circuit group 920′ biases the second output line group OL2s in a period where the first output signal group PO1s is output through the first output line group OL1s in a low speed mode.

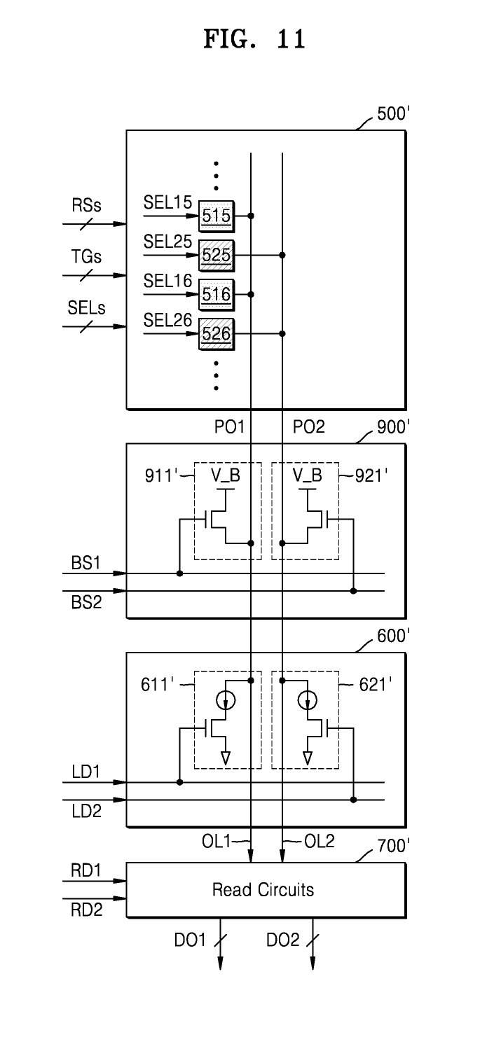

FIG. 11 is a block diagram of some pixels of the pixel array 500′ of FIG. 10, and circuits related to the pixels, according to an embodiment. In FIG. 11, pixels 515 and 516 may be included in a first pixel group 510′ of FIG. 10, and pixels 525 and 526 may be included in a second pixel group 520′ of FIG. 10. Also, in FIG. 11, the first output signal PO1 and the second output signal PO2 may be respectively included in the first output signal group PO1s and the second output signal group PO2s of FIG. 10, and the first output line OL1 and the second output line OL2 may be respectively included in the first output line group OL1s and the second output line group OL2s of FIG. 10. Descriptions of FIG. 11, which overlap those of FIG. 2A, will not be provided again, and FIG. 11 will be described with reference to FIG. 10.

Referring to FIG. 11, in the pixel array 500′, the pixels 515 and 516 of the first pixel group 510′ may be connected to the first output line OL1, and the pixels 525 and 526 of the second pixel group 520′ may be connected to the second output line OL2.

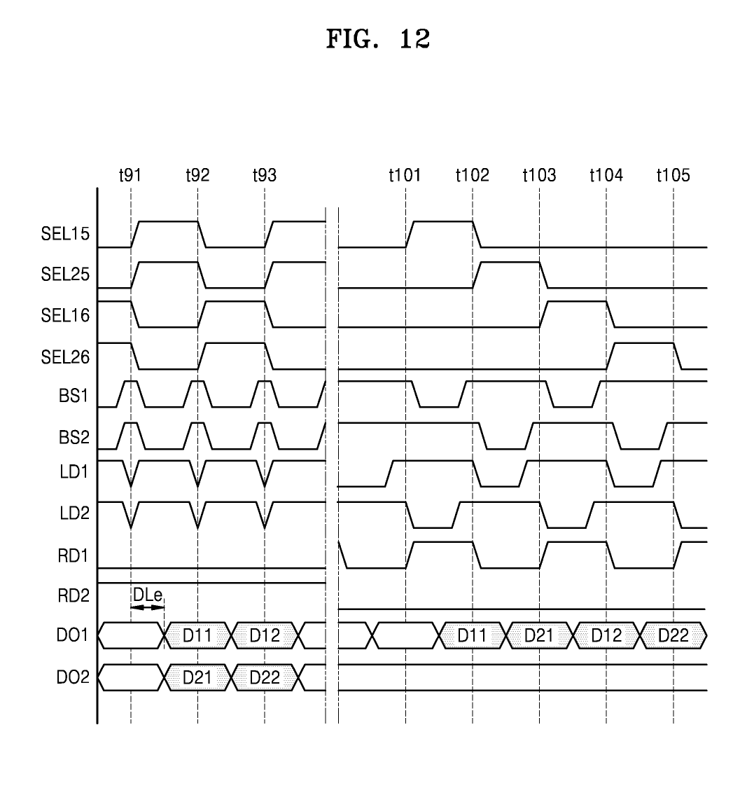

The bias circuits 900′ may receive first and second bias control signals BS1 and BS2 from among the bias control signals BSs provided from the column driver 400′ of FIG. 1, and may include a first bias circuit 911′ included in the first bias circuit group 910′ of FIG. 10 and a second bias circuit 921′ included in the second bias circuit group 920′ of FIG. 10. The first and second bias circuits 911′ and 921′ may have the same structure. For example, the first bias circuit 911′ may be connected to each of the first and second output lines OL1 and OL2. The first bias circuit 911′ may be enabled in response to the first bias control signal BS1 that is activated (for example, that has a power supply voltage), and may be disabled in response to second load control signal LD2 that is deactivated (for example, that has a ground voltage). The enabled first bias circuit 911′ may provide a bias voltage V_B to the first output line OL1. Details about the first and second bias control signals BS1 and BS2 will be described in detail below with reference to FIG. 12.

The load circuits 600′ may include a first load circuit 611′ included in a first load circuit group 610′ of FIG. 10, and a second load circuit 621′ included in a second load circuit group 620′ of FIG. 10. The readout circuits 700′ may be connected to the first and second output lines OL1 and 012, and may output the first and second digital output signals DO1 and DO2 by converting the first and second output signals PO1 and PO2.

FIG. 12 is a timing diagram of signals of FIG. 11 according to passage of time, according to an embodiment. For example, FIG. 12 shows the signals according to the passage of time, while the first and second digital output signals DO1 and DO2 are output from output signals output by the pixels 515, 516, 525, and 526 of FIG. 11 in each of the high speed mode and the low speed mode. Compared with FIG. 3, FIG. 12 further illustrates the first and second bias control signals BS1 and BS2, and other signals shown in FIG. 12 may be the same as or similar to corresponding signals of FIG. 3. FIG. 12 will be described with reference to FIGS. 10 and 11.

Referring to FIG. 12, the image sensor 10′ may operate in the high speed mode from a time t91 through a time t93, and the first and second load control signals LD1 and LD2 may be activated. As shown in FIG. 12, the first and second bias control signals BS1 and BS2 may have an activated pulse after an output signal is output from pixels disposed in one row and before an output signal is output from pixels disposed in a next row. For example, as shown in FIG. 12, the first and second bias control signals BS1 and BS2 may have an activated pulse near the time t92, and the first and second bias circuits 911′ and 921′ may be enabled near the time t92.

The image sensor 10′ may operate in the low speed mode from a time t101 through a time t105, and the first and second load control signals LD1 and LD2 may be toggled. In the low speed mode, the first and second bias control signals BS1 and BS2 may alternately enable and disable the first and second bias circuits 911′ and 921′. For example, as shown in FIG. 12, after the time t101 when the pixel 515 starts to output the first output signal PO1, the first bias control signal BS1 may be deactivated and thus the first bias circuit 911′ may be disabled, and the second bias control signal B S2 may be in an activated state and thus the second bias circuit 921′ may be enabled. Similarly, after the time t102 when the pixel 525 starts to output the second output signal PO2, the second bias control signal BS2 may be deactivated and thus the second bias circuit 921′ may be disabled, and the first bias control signal BS1 may be in an activated state and thus the first bias circuit 911′ may be enabled.

It should be noted that the above embodiments are not exclusive of each other, and various features from certain of the above-described embodiments may be used with other described embodiments. For example, an image sensor including the features of FIGS. 10 and 11 may include all of the details of the examples discussed in connection with FIGS. 1, 2A, 2B, and 3 to result in an example embodiment. Also, the features relating to the bias groups and bias circuits of FIGS. 10 and 11 can be included in the examples such as described in connection with FIGS. 4, 5A, and 5B to result in an example embodiment. An image sensor including the features of FIGS. 10 and 11, or FIGS. 1, 2A, 2B, and 3 can also include pixel arrangements and timing diagrams such as described in any of FIG. 6A, 6B, 7, or 8 to result in an example embodiment. Other combinations as would be apparent based on the context of the present disclosure are also included herein.

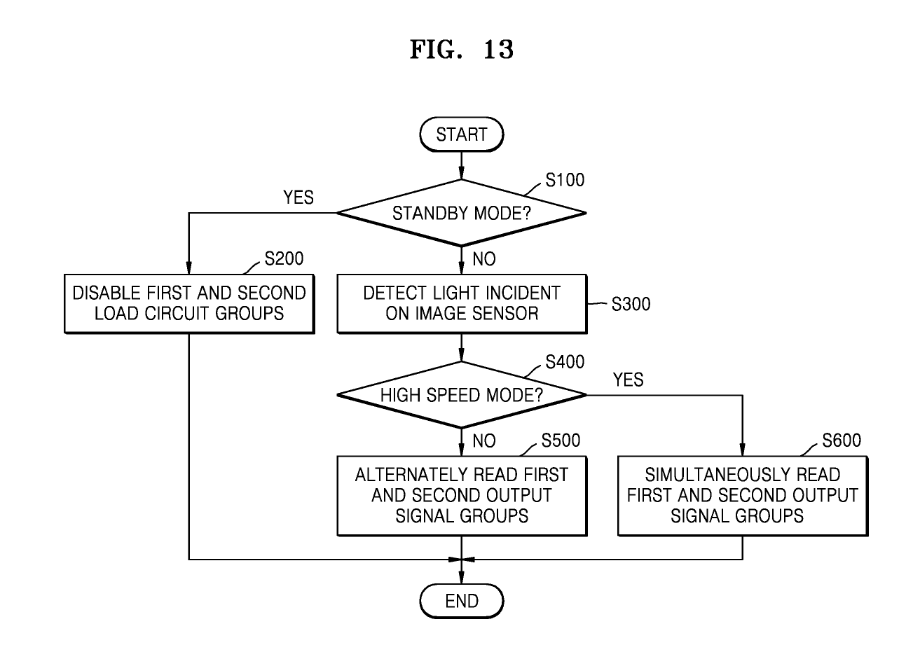

FIG. 13 is a flowchart of a method of operating an image sensor, according to an embodiment. For example, the method of FIG. 13 may be performed by the image sensor 10 of FIG. 1, or by the image sensors discussed in connection with FIG. 4, 10, or 6A, 6B, 7, and 8. For example, the method described in FIG. 13 may correspond to two of the output signal groups described in connection with FIG. 4, or may correspond to the output signal groups described in connection with FIG. 10. Also, the method of FIG. 13, though not shown, may apply where there are more than first and second signal groups, for example for an image sensor such as described in connection with FIG. 4 that includes n signal groups. Hereinafter, FIG. 13 will be described with reference to FIG. 1.

In operation S100, it is determined whether an operation mode of the image sensor 10 is a standby mode. For example, the control input signal C_IN may include information about the operation mode of the image sensor 10, and a value stored in the control registers 100 may be transmitted to other components through the control register signals CR1 through CR3, according to the control input signal C_IN. For example, the control registers 100 may store predetermined values that are selected based on the control input signal C_IN, so that a first set of values, or first codes, are sent as the control register signals CR1 through CR3 for a first mode (e.g., standby mode), a second set of values, or second codes, are sent as control register signals CR1 through CR3 for a second mode (e.g., low speed mode), and a third set of values, or second codes, are sent as control register signals CR1 through CR3 for a third mode (e.g., high speed mode). The components of the image sensor 10 that receive the control register signals CR1 through CR3 may control and determine the operation mode of the image sensor 10. When it is determined that the operation mode of the image sensor 10 is the standby mode, operation S200 may be performed, and when it is determined that the operation mode of the image sensor is not the standby mode, operation S300 may be performed.

In operation S200, the first and second load circuit groups 610 and 620 are disabled. For example, when the operation mode of the image sensor 10 is the standby mode according to the received second control register signal CR2, the column driver 400 may output the deactivated load control signals LDs so as to disable the first and second load circuit groups 610 and 620 included in the load circuits 600.

In operation S300, light incident on the image sensor 10 may be detected. For example, pixels included in the pixel array 500 may generate an electric signal by detecting intensity of light.

In operation S400, it is determined whether the operation mode of the image sensor 10 is a high speed mode. Like operation S100, the components included in the image sensor 10 may recognize the operation mode of the image sensor 10 based on the control register signals CR1 through CR3. When it is determined that the operation mode of the image sensor 10 is not the high speed mode, i.e., is a low speed mode, operation S500 is performed, and when it is determined that the operation mode is the high speed mode, operation S600 is performed.

In operation S500, the first and second output signal groups PO1s and PO2s are alternately read. The first output signal groups PO1s may include, for example, signals received from a first set of pixels in a particular first column of pixels. The second output signal groups PO2s may include, for example, signals received from a second set of pixels in the same first column. For example, when the operation mode is the low speed mode, the row driver 300 may provide the reset control signals RSs, the transmission control signals TGs, and the selection control signals SELs such that the first and second output signal groups PO1s and PO2s are alternately output from the pixel array 500, and the column driver 400 may provide the load control signals LDs and the readout control signals RDs such that the first and second output signal groups PO1s and PO2s are alternately read. Here, the column driver 400 may provide the load control signals LDs such that the second load circuit group 620 of the load circuits 600 is disabled for at least a part of a period where the first output signal group PO1s is output. Accordingly, a load circuit is disabled while not being used, and thus power consumption generated by the load circuit may be reduced.

In operation S600, the first and second output signal groups PO1s and PO2s are simultaneously read (e.g., signals from the first signal group PO1s are read at the same time as signals from the second signal group PO2s). For example, when the operation mode of the image sensor 10 is the high speed mode, the row driver 300 may provide the reset control signals RSs, the transmission control signals TGs, and the selection control signals SELs such that the first and second output signal groups PO1s and PO2s are simultaneously output from the pixel array 500 (each signal group may be output as a series of consecutive pixel signals), and the column driver 400 may provide the load control signals LDs and the readout control signals RDs such that the first and second load circuit groups 610 and 620 and the first and second readout circuit groups 710 and 720 are enabled.

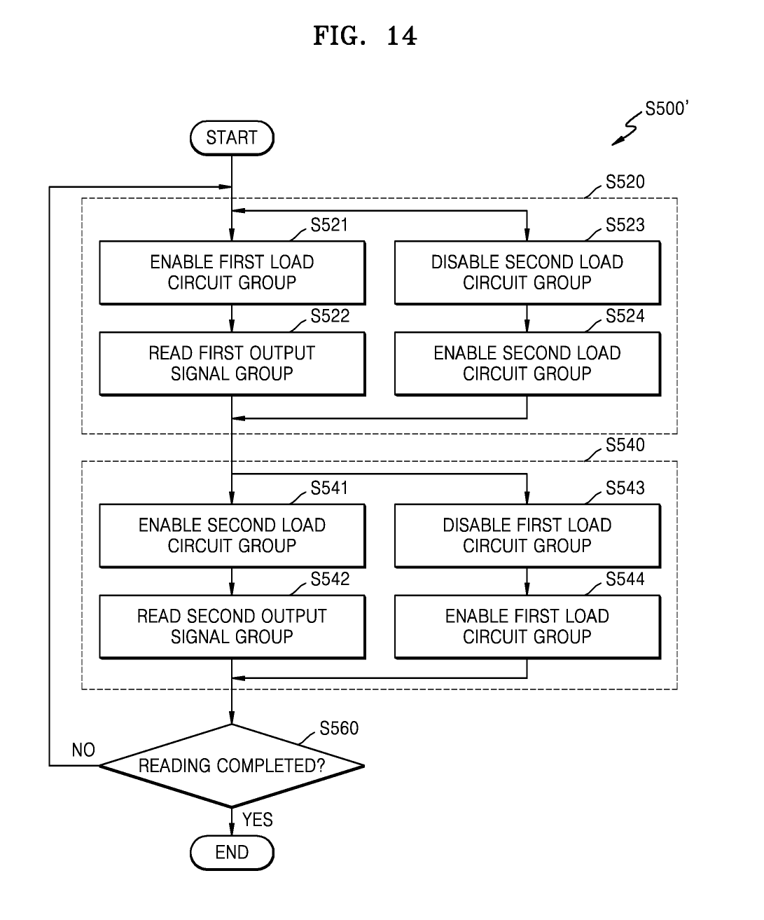

FIG. 14 is a flowchart of an example of operation S500 of FIG. 13, according to an embodiment. As described above with reference to FIG. 13, signals from first and second output signal groups are alternately read in operation S500′ of FIG. 14. As shown in FIG. 14, operation S500′ may include operation S520 corresponding to a period where the first output signal group is read and operation S540 corresponding to a period where the second output signal group is read.

In operation S520, operations S521 and S522, and operation S523 and S524 may be performed in parallel with respect to each other. For example, enabling of a first load circuit group in operation S521 and reading of the first output signal group in operation S522 may be sequentially performed, and disabling of a second load circuit group in operation S523 and enabling of the second load circuit group in operation S524 may be sequentially performed. A point in time when operation S524 starts to be performed may be determined based on a time required to change the disabled second load circuit group to a steady state before operation S540 starts to be performed, such that the second output signal group is normally output when operation S540 starts to be performed.

Like operation S520, in operation S540, operations S541 and S542, and operation S543 and S544 may be performed in parallel with respect to each other. For example, enabling of the second load circuit group in operation S541 and reading of the second output signal group in operation S542 may be sequentially performed, and disabling of the first load circuit group in operation S543 and enabling of the first load circuit group in operation S544 may be sequentially performed. A point in time when operation S544 starts to be performed may be determined based on a time required to change the disabled first load circuit group to a steady state before operation S520 starts to be performed, such that the first output signal group is normally output when operation S520 starts to be performed after it is determined that reading is not completed in operation S560.

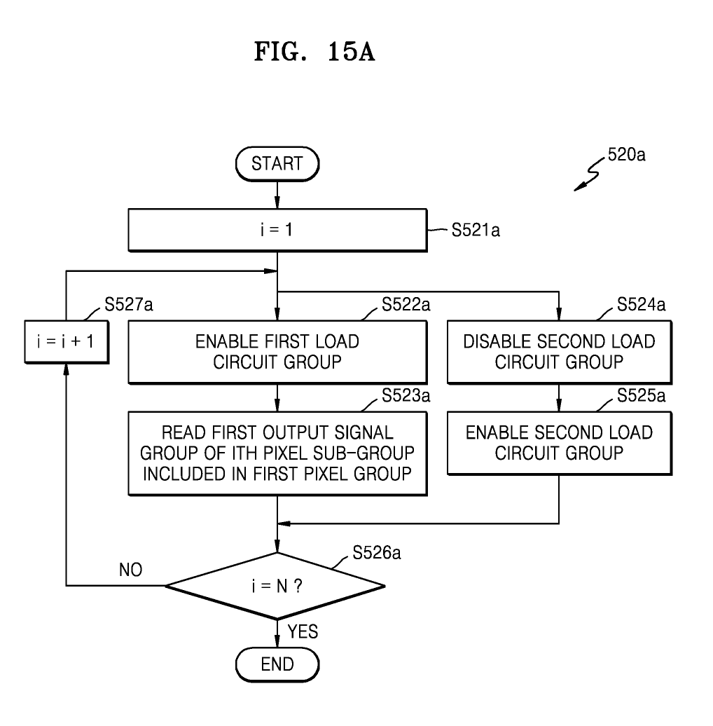

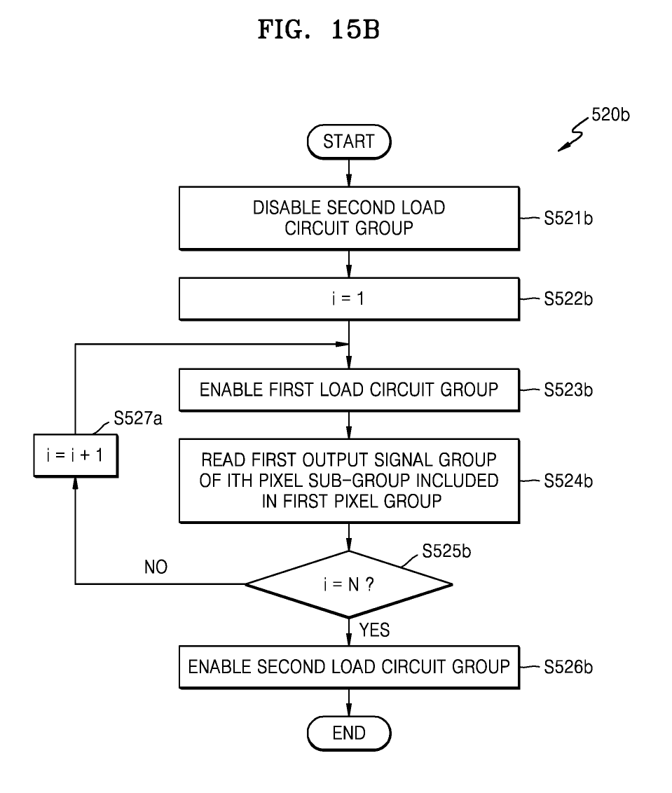

FIGS. 15A and 15B are flowcharts of different examples of operations S520 of FIG. 14, according to embodiments. For example, FIGS. 15A and 15B illustrate operations S520a and S520b where a first output signal group of a first pixel group is continuously output, and although not shown, a second output signal group may be continuously output after operations of FIGS. 15A and 15B are performed. For example, As examples of operations of reading, by an image sensor including a shared-pixel including a plurality of sub-pixels, a first output signal group, FIG. 15A may correspond to the timing diagram of FIG. 7, and FIG. 15B may correspond to the timing diagram of FIG. 8. Hereinafter, FIGS. 15A and 15B will be described with reference to FIG. 6A.

Referring to FIG. 15A, an initialization operation is performed in operation S521a. For example, as shown in FIG. 15a, a variable i may be set to 1. The variable i may increase by one whenever an output signal corresponding to each of the sub-pixels included in the shared-pixel of the first pixel group is output. Then, operation S522a and S523a, and operations S524a and S525a may be performed in parallel with respect to each other.

In operation S522a, a first load circuit group is enabled, and then in operation S523a, a first output signal group of an i^{th} pixel sub-group included in the first pixel group is read. A pixel sub-group may denote pixels simultaneously outputting output signals through a first or second output line group, and according to an embodiment, the pixels included in the pixel sub-group may detect light having the same wavelength region. For example, the sub-pixels X11 through X14 and X21 through X24 of FIG. 6A may be included in different pixel sub-groups. In other words, the pixel sub-group including the sub-pixel X11 may include a sub-pixel included in each of shared-pixels of another first pixel group receiving the selection control signal SEL10.

In operation S524a, a second load circuit group is disabled, and then in operation S525a, the second load circuit group is enabled. For example, as described above with reference to FIG. 7, the second load circuit group may be enabled and disabled whenever each of the sub-pixels included in the shared-pixel of the first pixel group generates an output signal.

In operation S526a, it is determined whether output signals generated by the sub-pixels included in the shared-pixel of the first pixel group are all read. For example, it is determined whether the variable i matches N that is a value indicating the number of sub-pixels included in the shared-pixel of the first pixel group. When the variable i and N do not match, the variable i may be increased by 1 in operation S527a, and then operations S522a and S524a may be performed.

Referring to FIG. 15B, the second load circuit group is disabled in operation S521b, and the variable i is set to 1 as an initialization operation in operation S522b. Then, the first load circuit group is enabled in operation S523b, and the first output signal group of the i^{th} pixel sub-group included in the first pixel group is read in operation S524b. In operation S525b, the variable i and N are compared to determine whether reading of the sub-pixels included in the shared-pixel of the first pixel group is completed. When the variable i and N do not match, the variable i is increased by 1 in operation S527a, and operations S523b, S524b, and S525b are sequentially performed again.

When the variable i and N match each other in operation S525b, e.g., when the reading of the output signals generated by the sub-pixels included in the shared-pixel of the first pixel group is completed, the second load circuit group is enabled in operation S526b. In other words, as described above with reference to FIG. 8, the second load circuit group may be disabled while the output signals corresponding to the sub-pixels included in the shared-pixel of the first pixel group is disabled, and may be enabled after the output signals of the sub-pixels included in the shared-pixel of the first pixel group are output (or during a period where the last output signal of the output signals is output).

While the inventive concept has been particularly shown and described with reference to embodiments thereof, it will be understood that various changes in form and details may be made therein without departing from the spirit and scope of the following claims.

1. An image sensor supporting a low speed mode and a high speed mode, the image sensor comprising:
a pixel array comprising a first pixel group including at least a first row of pixels and a second pixel group including at least a second row of pixels;
a first output line group including a plurality of output lines connected to pixels of the first pixel group and configured to output a first set of output signals from the first row of pixels of the first pixel group during a first period of the low speed mode;
a second output line group including a plurality of output lines connected to pixels of the second pixel group and configured to output a second set of output signals from the second row of pixels of the second pixel group during a second period of the low speed mode;
a first load circuit group including a plurality of first load circuits configured to provide respective current loads for the plurality of output lines of the first output line group, each first load circuit of the first load circuit group configured to receive a first load control signal;
a second load circuit group including a plurality of second load circuits configured to provide respective current loads for the plurality of output lines of the second output line group, each second load circuit of the second load circuit group configured to receive a second load control signal; and
a control circuit configured to provide the second load control signal such that the second load circuit group is disabled during at least a part of the first period.

2. The image sensor of claim 1, wherein the control circuit is configured to provide the first load control signal such that the first load circuit group is disabled during at least a part of the second period.

3. The image sensor of claim 1, wherein the control circuit is configured to provide the second load control signal such that the second load circuit group is enabled during a third period shorter than the first period before the first period ends.

4. The image sensor of claim 3, wherein the third period is equal to or longer than a time needed for the second load circuit group to reach a steady state.

5. The image sensor of claim 4, wherein the first and second load circuits of the respective first and second load circuit groups each comprise a current source and a switch connected to the current source, and
the third period is equal to or longer than a time needed for an output current of each current source to reach a pre-set size as the switch is turned on according to the first and second respective load control signals.

6. (canceled)

7. The image sensor of claim 1, wherein the first set of output signals includes a first sequence of output signals sequentially output through the first output line group, in a series of sub-periods included in the first period, and
the control circuit is configured to toggle the second load control signal such that the second load circuit group is enabled after being disabled in each sub-period of the series of sub-periods.

8. The image sensor of claim 7, configured such that a period during which the second load circuit group is enabled in each sub-period of the series of sub-periods is equal to or longer than a time needed for the second load circuit group to be in a steady state.

9. The image sensor of claim 8, wherein pixels included in each of the pixel sub-groups are configured to detect light of the same wavelength region.

10. The image sensor of claim 1, further comprising first and second bias circuit groups configured to apply a bias voltage respectively to the first and second output line groups, and respectively receive first and second bias control signals,
wherein the control circuit is configured to provide the first and second bias control signals such that the second bias circuit group is enabled in the first period and the first bias circuit group is enabled in the second period.

11. The image sensor of claim 1, wherein the image sensor is configured to simultaneously output the first set of output signals with the second set of output signals in the high speed mode, and
the control circuit is configured to provide the first and second load control signals such that the first and second load circuit groups are respectively enabled in the high speed mode.

12. The image sensor of claim 11, further comprising:
a routing circuit configured to receive at least one readout control signal and connected to the first and second output line groups; and
first and second readout circuit groups connected to the routing circuit,
wherein the control circuit is configured to provide the at least one readout control signal such that the first set of output signals and the second set of output signals are respectively provided to the first and second readout circuit groups in the high speed mode, and are provided to the first readout circuit group in the low speed mode.

13. The image sensor of claim 12, wherein the second readout circuit group is enabled in the high speed mode and disabled in the low speed mode in response to the at least one readout control signal.

14. The image sensor of claim 1, wherein the control circuit is configured to provide the first and second load control signals such that the first and second load circuit groups are disabled in a standby mode.

15. A method of operating an image sensor supporting a low speed mode and a high speed mode, the method comprising:
outputting a first set of output signals from a first pixel group to a first output line group by enabling, during a first period of the low speed mode, a first load circuit group connected to the first set of output signals;
outputting a second set of output signals from a second pixel group to a second output line group by enabling, during a second period of the low speed mode different from the first period, a second load circuit group connected to the second set of output signals; and
disabling the second load circuit group during at least a part of the first period.

16. The method of claim 15, further comprising disabling the first load circuit group during at least a part of the second period.

17. The method of claim 16, further comprising enabling the second load circuit group during a third period shorter than the first period before the first period ends.

18. The method of claim 17, wherein the third period is equal to or longer than time needed for the second load circuit group to reach a steady state.

19. The method of claim 15, wherein the outputting of the first set of output signals to the first output line group comprises sequentially outputting signals of pixel sub-groups included in the first pixel group to the first output line group in a series of sub-periods included in the first period,
the disabling of the second load circuit group comprises disabling the second load circuit group in each sub-period of the series of sub-periods, and
the method further comprises, after the disabling of the second load circuit group, enabling the second load circuit group in a partial sub-period in each of the series of sub-periods.

20-23. (canceled)

24. A method of operating an image sensor having a pixel array including a plurality of rows of pixels, comprising:
during a low speed mode:
during a first time period, enabling a first load circuit connected to a first output line connected to a plurality of pixels in a first column of the pixel array,
during the first time period, outputting pixel data from a first pixel in a first row and the first column of the pixel array,
during the first time period, disabling a second load circuit connected to a second output line connected to a plurality of pixels in a second column of the pixel array,
during a second time period different from the first time period, enabling the second load circuit connected to the second output line,
during the second time period, outputting pixel data from a second pixel in a second row and the second column of the pixel array, and
during the second time period, disabling the first load circuit; and
during a high speed mode:
enabling the first load circuit and the second load circuit simultaneously in order to output pixel data from the first pixel simultaneously with outputting pixel data from the second pixel.

25. The method of claim 24, further comprising:
during the low speed mode:
during a third time period after the first and second time periods, enabling the first load circuit, outputting pixel data from a first pixel in a third row and the first column of the pixel array, and disabling the second load circuit,
during a fourth time period after the third time period, enabling the second load circuit, outputting pixel data from a first pixel in a fourth row and the second column of the pixel array, and disabling the first load circuit.

26. (canceled)
